(19) United States
(12) Patent Application Publication
(10) Pub. No.: US 2019/0364298 A1
(43) Pub. Date: Nov. 28, 2019

(54) IMAGE ENCODING/DECODING METHOD AND DEVICE, AND RECORDING MEDIUM HAVING BITSTREAM STORED THEREON

(71) Applicants: ELECTRONICS AND TELECOMMUNICATIONS RESEARCH INSTITUTE, Daejeon (KR); UNIVERSITY-INDUSTRY COOPERATION GROUP OF KYUNG HEE UNIVERSITY, Yongin-si (KR)

(72) Inventors: Jung Won KANG, Daejeon (KR); Hyun Suk KO, Daejeon (KR); Sung Chang LIM, Daejeon (KR); Jin Ho LEE, Daejeon (KR); Ha Hyun LEE, Seoul (KR); Dong San JUN, Daejeon (KR); Seung Hyun CHO, Daejeon (KR); Hui Yong KIM, Daejeon (KR); Jin Soo CHOI, Daejeon (KR); Gwang Hoon PARK, Seongnam-si (KR); Tae Hyun KIM, Hwaseong-si (KR); Dae Young LEE, Ansan-si (KR)

(73) Assignees: ELECTRONICS AND TELECOMMUNICATIONS RESEARCH INSTITUTE, Daejeon (KR); UNIVERSITY-INDUSTRY COOPERATION GROUP OF KYUNG HEE UNIVERSITY, Yongin-si (KR)

(21) Appl. No.: 16/349,649

(22) PCT Filed: Nov. 22, 2017
(86) PCT No.: PCT/KR2017/013330

§ 371 Date: May 14, 2019

(30) Foreign Application Priority Data
Nov. 22, 2016 (KR) 10-2016-0155812

(51) Int. Cl. H04N 19/527; H04N 19/105; H04N 19/139; H04N 19/513

(52) U.S. Cl. CPC H04N 19/527; H04N 19/521; H04N 19/139; H04N 19/105

(57) ABSTRACT

The present invention relates to image encoding and decoding methods. An image decoding method for the same may include: determining whether or not to use a global motion; selectively receiving global motion information according to the determination result; and performing inter-prediction based on the global motion information.

### TECHNICAL FIELD

The present invention relates to a method and apparatus for image encoding/decoding, and a recording medium storing a bitstream. More particularly, the present invention relates to a method and apparatus for image encoding/decoding using a method of selectively omitting global motion information.

### BACKGROUND ART

Recently, demands for high-resolution and high-quality images such as high definition (HD) images and ultra high definition (UHD) images, have increased in various application fields. However, higher resolution and quality images have increased amounts of image data in comparison with conventional image data. Therefore, when transmitting image data by using a medium such as conventional wired and wireless broadband networks, or when storing image data by using a conventional storage medium, costs of transmitting and storing increase. In order to solve these problems occurring with an increase in resolution and quality of image data, high-efficiency image compression techniques are required.

Video compression methods includes various methods, including: an inter-prediction method of predicting a pixel value included in a current picture from a previous or subsequent picture of the current picture; an intra-prediction method of predicting a pixel value included in a current picture by using pixel information in the current picture; an entropy encoding method of assigning a short code to a value with a high occurrence frequency and assigning a long code to a value with a low occurrence frequency; etc. Image data may be effectively compressed by using such image compression technology, and may be transmitted or stored.

When the entire image includes motions having the same tendency due to camera work, inter-prediction may be performed by using global motion information.

Global motion information may occupy a large number of bits according to accuracy and a representing range thereof. In addition, when all global motions with respective reference frames are represented, more amount of bits may be required. Accordingly, coding efficiency decreases.

### DISCLOSURE

### Technical Problem

An object of the present invent is to provide a method and apparatus for image encoding/decoding wherein compression efficiency is improved.

In addition, the present invention may provide a method of selectively omitting global motion information such that image encoding/decoding efficiency is improved.

### Technical Solution

According to the present invention, an image decoding method may include: determining whether or not to use a global motion; selectively receiving global motion information according to the determination result; and performing inter-prediction based on the global motion information.

In the image decoding method, in the determining of whether or not to use the global motion, whether or not to use the global motion may be determined based on global motion use/non-use information obtained from a bitstream.

In the image decoding method, in the determining of whether or not to use the global motion, whether or not to use the global motion may be determined based on a prediction result of coding efficiency according to whether or not to use a global motion of a reference picture within a reference picture list of a current picture.

In the image decoding method, in determining of whether or not to use the global motion, whether or not to use the global motion may be determined based on a unit identical to or higher than a unit in which global motion information is transmitted.

In the image decoding method, in determining of whether or not to use the global motion, whether or not to use the global motion may be determined based on a picture order count (POC) of a reference picture within a reference picture list of a current picture.

In the image decoding method, in determining of whether or not to use the global motion, whether or not to use the global motion may be determined based at least one of a number of reference pictures within a reference picture list of a current picture and a POC distance between the current picture and the reference picture.

In the image decoding method, the determining of whether or not to use the global motion may include: predicting global motion information; and determining whether or not to use the global motion based on a characteristic of the predicted global motion information.

In the image decoding method, the characteristic of the predicted global motion information may include at least one of a rotation, a scaling up, a scaling down, a parallel movement, and a perspective movement.

In the image decoding method, in the determining of whether or not to use the global motion, the global motion may be used when the characteristic of the predicted global motion information corresponds to at least one of the rotation, the scaling up, the scaling down, the parallel movement, and the perspective movement.

In the image decoding method, in the determining of whether or not to use the global motion, whether or not to use the global motion may be determined based on a size of the predicted global motion information.

Meanwhile, according to the present invention, an image encoding method may include: determining whether or not to use a global motion; and selectively encoding at least one of global motion use/non-use information, and global motion information according to the determination result.

In the image encoding method, in the determining of whether or not to use the global motion, whether or not to use the global motion may be determined based on a coding efficiency according to whether or not to use a global motion.

In the image encoding method, in the determining of whether or not to use the global motion, whether or not to use the global motion may be determined based on a prediction result of the coding efficiency according to whether or not to use the global motion.

In the image encoding method, in the determining of whether or not to use the global motion, whether or not to use the global motion may be determined based on a unit identical to or higher than a unit in which global motion information is transmitted

In the image encoding method, in the determining whether or not to use the global motion, whether or not to use the global motion may be determined based a POC of a reference picture within a reference picture list of a current picture.

In the image encoding method, in the determining whether or not to use the global motion, whether or not to use the global motion may be determined based on at least one of a number of reference pictures within a reference picture list of a current picture, and a POC distance between the current picture and the reference picture.

In the image encoding method, in the determining whether or not to use the global motion, whether or not to use the global motion may include determining whether or not to use the global motion based on a characteristic of global motion information.

In the image encoding method, the determining of whether or not to use the global motion may include: predicting global motion information; and determining whether or not to use the global motion based on a characteristic of the predicted global motion information.

In the image encoding method, the characteristic of the predicted global motion information may include at least one of a rotation, a scaling up, a scaling down, a parallel movement, and a perspective movement.

In the image encoding method, in the determining of whether or not to use the global motion, the global motion may be used when the characteristic of the predicted global motion information corresponds to at least one of the rotation, the scaling up, the scaling down, the parallel movement, and the perspective movement.

In the image encoding method, in the determining of whether or not to use the global motion, whether or not to use the global motion may be determined based on a size of the predicted global motion information.

Meanwhile, according to the present invention, a storage medium may store a bitstream generated by an image encoding method including: determining whether or not to use a global motion; and selectively encoding at least one of global motion use/non-use information, and global motion information according to the determination result.

### Advantageous Effects

According to the present invention, there may be provided a method and apparatus for image encoding/decoding in which compression efficiency is improved.

In addition, according to the present invention, there may be provided a method and apparatus for image encoding/decoding using inter-prediction in which compression efficiency is improved.

In addition, according to the present invention, there may be provided a recording medium storing a bitstream generated by an image encoding method or apparatus of the present invention.

In addition, according to the present invention, coding efficiency may be improved by omitting global motion information.

### DESCRIPTION OF DRAWINGS

FIG. 1 is a block diagram showing a configuration of an encoding apparatus according to an embodiment to which the present invention is applied.

FIG. 2 is a block diagram showing a configuration of a decoding apparatus according to an embodiment to which the present invention is applied.

FIG. 3 is a view showing a division structure of an image when encoding and decoding the image.

FIG. 4 is a view showing an example process of inter-prediction.

FIG. 5 (FIGS. 5a to 5d) is a view for illustrating an example of generating a global motion.

FIG. 6 is a view for illustrating an example method of representing a global motion of an image.

FIG. 7 is a flowchart for illustrating an encoding method and a decoding method of using global motion information.

FIG. 8 is a view showing a transform example when each point of an image moves in parallel.

FIG. 9 is a view showing an image transform example transformed through a size modification.

FIG. 10 is a view showing an image transform example transformed through a rotation modification.

FIG. 11 is a view showing an example of an affine transform.

FIG. 12 is a view showing an example of a projective transform.

FIG. 13 is a view for illustrating an example of image encoding and decoding methods using an image geometric transform.

FIG. 14 is a view for illustrating an example of an encoding apparatus using an image geometric transform.

FIG. 15 is a view for illustrating an example of representing a global motion that requires a large number of bits.

FIG. 16 is a view for illustrating a method of omitting global motion information.

FIG. 17 (FIGS. 17a and 17b) is a flowchart showing an example of encoding and decoding methods using a method of selectively omitting global motion information.

FIG. 18 is a view showing an example of an encoding apparatus to which the method of selectively omitting global motion information is applied.

FIG. 19 (FIGS. 19a and 19b) is a flowchart showing an example of a result of inter-prediction using a global motion, and an encoding method of determining whether or not to use a global motion.

FIG. 20 is a view showing an example of an image encoding apparatus for determining whether or not to use a global motion of FIG. 19.

FIG. 21 is a view showing an example of a method of configuring a reference frame in a group of picture (GOP) unit.

FIG. 22 (FIGS. 22a and 22b) is a flowchart for illustrating encoding and decoding methods of determining whether or not to use a global motion according to a pre-defined order in a GOP unit

FIG. 23 is a view for illustrating a method of configuring a reference frame to which the method of determining whether or not to use a global motion according to a pre-defined order of FIG. 22 is applied.

FIG. 24 (FIGS. 24a and 24b) is a flowchart for illustrating an encoding method of determining whether or not to adaptively use a global motion according to configuration information of a reference picture.

FIG. 25 (FIGS. 25a and 25b) is a flowchart for illustrating an example of decoding method in association with FIG. 24.

FIG. 26 is a view showing an example of configuring a reference picture to which examples of FIGS. 24 and 25 are applied.

FIG. 27 is a view showing an example of an encoding apparatus of determining whether or not to use a global motion by using a method of analyzing a configuration of a reference picture.

FIG. 28 (FIGS. 28a and 28b) is a flowchart showing an example of encoding and decoding methods of determining whether or not to use global motion information by analyzing generated global motion information.

FIG. 29 is a view showing an example of an encoding apparatus to which the encoding and decoding methods of FIG. 28 are applied.

FIG. 30 (FIGS. 30a and 30b) is a view showing encoding and decoding methods of determining whether or not to use global motion information by analyzing predicted global motion information.

FIG. 31 is a view showing an example of an encoding apparatus to which the methods of FIG. 30 are applied.

FIG. 32 is a flowchart showing entropy encoding and decoding methods of a signal representing whether or not to use a global motion.

FIG. 33 is a view showing an example when the present invention is applied to a PPS syntax in a picture unit.

FIG. 34 is a view showing an example when the present invention is applied to a header syntax in a slice unit.

FIG. 35 is a view showing an example when the present invention is applied to a PPS syntax in a reference picture unit.

FIG. 34 is a view showing an example when the present invention is applied to a slice header syntax in a reference picture unit.

FIG. 37 is a flowchart for illustrating an image decoding method according to an embodiment of the present invention.

FIG. 38 is a flowchart for illustrating an image encoding method according to an embodiment of the present invention.

### MODE FOR INVENTION

A variety of modifications may be made to the present invention and there are various embodiments of the present invention, examples of which will now be provided with reference to drawings and described in detail. However, the present invention is not limited thereto, although the exemplary embodiments can be construed as including all modifications, equivalents, or substitutes in a technical concept and a technical scope of the present invention. The similar reference numerals refer to the same or similar functions in various aspects. In the drawings, the shapes and dimensions of elements may be exaggerated for clarity. In the following detailed description of the present invention, references are made to the accompanying drawings that show, by way of illustration, specific embodiments in which the invention may be practiced. These embodiments are described in sufficient detail to enable those skilled in the art to implement the present disclosure. It should be understood that various embodiments of the present disclosure, although different, are not necessarily mutually exclusive. For example, specific features, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to what the claims claim.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present invention, and the ‘second’ component may also be similarly named the ‘first’ component. The term ‘and/or’ includes a combination of a plurality of items or any one of a plurality of terms.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. In contrast, it should be understood that when an element is referred to as being “directly coupled” or “directly connected” to another element, there are no intervening elements present.

Furthermore, constitutional parts shown in the embodiments of the present invention are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In other words, when a specific element is referred to as being “included”, elements other than the corresponding element are not excluded, but additional elements may be included in embodiments of the present invention or the scope of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

Hereinafter, embodiments of the present invention will be described in detail with reference to the accompanying drawings. In describing exemplary embodiments of the present invention, well-known functions or constructions will not be described in detail since they may unnecessarily obscure the understanding of the present invention. The same constituent elements in the drawings are denoted by the same reference numerals, and a repeated description of the same elements will be omitted.

In addition, hereinafter, an image may mean a picture configuring a video, or may mean the video itself. For example, “encoding or decoding or both of an image” may mean “encoding or decoding or both of a video”, and may mean “encoding or decoding or both of one image among images of a video.” Here, a picture and the image may have the same meaning.

### Description of Terms

Encoder: means an apparatus performing encoding.

Decoder: means an apparatus performing decoding

Block: is an M×N array of a sample. Herein, M and N mean positive integers, and the block may mean a sample array of a two-dimensional form. The block may refer to a unit. A current block my mean an encoding target block that becomes a target when encoding, or a decoding target block that becomes a target when decoding. In addition, the current block may be at least one of an encode block, a prediction block, a residual block, and a transform block.

Sample: is a basic unit constituting a block. It may be expressed as a value from 0 to 2^{Bd}−1 according to a bit depth (B_{d}). In the present invention, the sample may be used as a meaning of a pixel.

Unit: refers to an encoding and decoding unit. When encoding and decoding an image, the unit may be a region generated by partitioning a single image. In addition, the unit may mean a subdivided unit when a single image is partitioned into subdivided units during encoding or decoding. When encoding and decoding an image, a predetermined process for each unit may be performed. A single unit may be partitioned into sub-units that have sizes smaller than the size of the unit. Depending on functions, the unit may mean a block, a macroblock, a coding tree unit, a code tree block, a coding unit, a coding block), a prediction unit, a prediction block, a residual unit), a residual block, a transform unit, a transform block, etc. In addition, in order to distinguish a unit from a block, the unit may include a luma component block, a chroma component block associated with the luma component block, and a syntax element of each color component block. The unit may have various sizes and forms, and particularly, the form of the unit may be a two-dimensional geometrical figure such as a rectangular shape, a square shape, a trapezoid shape, a triangular shape, a pentagonal shape, etc. In addition, unit information may include at least one of a unit type indicating the coding unit, the prediction unit, the transform unit, etc., and a unit size, a unit depth, a sequence of encoding and decoding of a unit, etc.

Coding Tree Unit: is configured with a single coding tree block of a luma component Y, and two coding tree blocks related to chroma components Cb and Cr. In addition, it may mean that including the blocks and a syntax element of each block. Each coding tree unit may be partitioned by using at least one of a quad-tree partitioning method and a binary-tree partitioning method to configure a lower unit such as coding unit, prediction unit, transform unit, etc. It may be used as a term for designating a pixel block that becomes a process unit when encoding/decoding an image as an input image.

Coding Tree Block: may be used as a term for designating any one of a Y coding tree block, Cb coding tree block, and Cr coding tree block.

Neighbor Block: means a block adjacent to a current block. The block adjacent to the current block may mean a block that comes into contact with a boundary of the current block, or a block positioned within a predetermined distance from the current block. The neighbor block may mean a block adjacent to a vertex of the current block. Herein, the block adjacent to the vertex of the current block may mean a block vertically adjacent to a neighbor block that is horizontally adjacent to the current block, or a block horizontally adjacent to a neighbor block that is vertically adjacent to the current block.

Reconstructed Neighbor block: means a neighbor block adjacent to a current block and which has been already spatially/temporally encoded or decoded. Herein, the reconstructed neighbor block may mean a reconstructed neighbor unit. A reconstructed spatial neighbor block may be a block within a current picture and which has been already reconstructed through encoding or decoding or both. A reconstructed temporal neighbor block is a block at the same position as the current block of the current picture within a reference picture, or a neighbor block thereof.

Unit Depth: means a partitioned degree of a unit. In a tree structure, a root node may be the highest node, and a leaf node may be the lowest node. In addition, when a unit is expressed as a tree structure, a level in which a unit is present may mean a unit depth.

Bitstream: means a bitstream including encoding image information.

Parameter Set: corresponds to header information among a configuration within a bitstream. At least one of a video parameter set, a sequence parameter set, a picture parameter set, and an adaptation parameter set may be included in a parameter set. In addition, a parameter set may include a slice header, and tile header information.

Parsing: may mean determination of a value of a syntax element by performing entropy decoding, or may mean the entropy decoding itself.

Symbol: may mean at least one of a syntax element, a coding parameter, and a transform coefficient value of an encoding/decoding target unit. In addition, the symbol may mean an entropy encoding target or an entropy decoding result.

Prediction Unit: means a basic unit when performing prediction such as inter-prediction, intra-prediction, inter-compensation, intra-compensation, and motion compensation. A single prediction unit may be partitioned into a plurality of partitions with a small size, or may be partitioned into a lower prediction unit.

Prediction Unit Partition: means a form obtained by partitioning a prediction unit.

Reference Picture List: means a list including one or more reference pictures used for inter-picture prediction or motion compensation. LC (List Combined), L0 (List 0), L1 (List 1), L2 (List 2), L3 (List 3) and the like are types of reference picture lists. One or more reference picture lists may be used for inter-picture prediction.

Inter-picture prediction Indicator: may mean an inter-picture prediction direction (uni-directional prediction, bi-directional prediction, and the like) of a current block. Alternatively, the inter-picture prediction indicator may mean the number of reference pictures used to generate a prediction block of a current block. Further alternatively, the inter-picture prediction indicator may mean the number of prediction blocks used to perform inter-picture prediction or motion compensation with respect to a current block.

Reference Picture Index: means an index indicating a specific reference picture in a reference picture list.

Reference Picture: may mean a picture to which a specific block refers for inter-picture prediction or motion compensation.

Motion Vector: is a two-dimensional vector used for inter-picture prediction or motion compensation and may mean an offset between a reference picture and an encoding/decoding target picture. For example, (mvX, mvY) may represent a motion vector, mvX may represent a horizontal component, and mvY may represent a vertical component.

Motion Vector Candidate: may mean a block that becomes a prediction candidate when predicting a motion vector, or a motion vector of the block. A motion vector candidate may be listed in a motion vector candidate list.

Motion Vector Candidate List: may mean a list of motion vector candidates.

Motion Vector Candidate Index: means an indicator indicating a motion vector candidate in a motion vector candidate list. It is also referred to as an index of a motion vector predictor.

Motion Information: may mean information including a motion vector, a reference picture index, an inter-picture prediction indicator, and at least any one among reference picture list information, a reference picture, a motion vector candidate, a motion vector candidate index, a merge candidate, and a merge index.

Merge Candidate List: means a list composed of merge candidates.

Merge Candidate: means a spatial merge candidate, a temporal merge candidate, a combined merge candidate, a combined bi-prediction merge candidate, a zero merge candidate, or the like. The merge candidate may have an inter-picture prediction indicator, a reference picture index for each list, and motion information such as a motion vector.

Merge Index: means information indicating a merge candidate within a merge candidate list. The merge index may indicate a block used to derive a merge candidate, among reconstructed blocks spatially and/or temporally adjacent to a current block. The merge index may indicate at least one item in the motion information possessed by a merge candidate.

Transform Unit: means a basic unit when performing encoding/decoding such as transform, inverse-transform, quantization, dequantization, transform coefficient encoding/decoding of a residual signal. A single transform unit may be partitioned into a plurality of transform units having a small size.

Scaling: means a process of multiplying a transform coefficient level by a factor. A transform coefficient may be generated by scaling a transform coefficient level. The scaling also may be referred to as dequantization.

Quantization Parameter: may mean a value used when generating a transform coefficient level of a transform coefficient during quantization. The quantization parameter also may mean a value used when generating a transform coefficient by scaling a transform coefficient level during dequantization. The quantization parameter may be a value mapped on a quantization step size.

Delta Quantization Parameter: means a difference value between a predicted quantization parameter and a quantization parameter of an encoding/decoding target unit.

Scan: means a method of sequencing coefficients within a block or a matrix. For example, changing a two-dimensional matrix of coefficients into a one-dimensional matrix may be referred to as scanning, and changing a one-dimensional matrix of coefficients into a two-dimensional matrix may be referred to as scanning or inverse scanning.

Transform Coefficient: may mean a coefficient value generated after transform is performed in an encoder. It may mean a coefficient value generated after at least one of entropy decoding and dequantization is performed in a decoder. A quantized level obtained by quantizing a transform coefficient or a residual signal, or a quantized transform coefficient level also may fall within the meaning of the transform coefficient.

Quantized Level: means a value generated by quantizing a transform coefficient or a residual signal in an encoder. Alternatively, the quantized level may mean a value that is a dequantization target to undergo dequantization in a decoder. Similarly, a quantized transform coefficient level that is a result of transform and quantization also may fall within the meaning of the quantized level.

Non-zero Transform Coefficient: means a transform coefficient having a value other than zero, or a transform coefficient level having a value other than zero.

Quantization Matrix: means a matrix used in a quantization process or a dequantization process performed to improve subjective or objective image quality. The quantization matrix also may be referred to as a scaling list.

Quantization Matrix Coefficient: means each element within a quantization matrix. The quantization matrix coefficient also may be referred to as a matrix coefficient.

Default Matrix: means a predetermined quantization matrix preliminarily defined in an encoder or a decoder.

Non-default Matrix: means a quantization matrix that is not preliminarily defined in an encoder or a decoder but is signaled by a user.

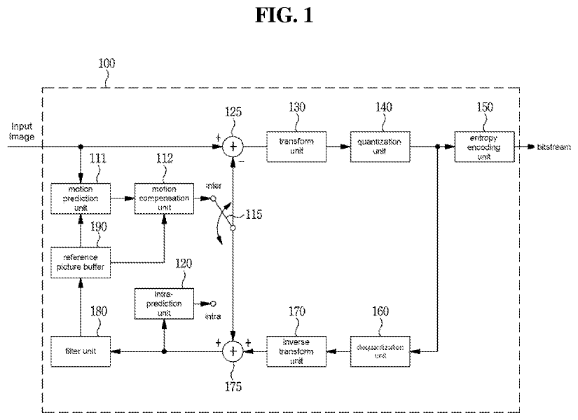

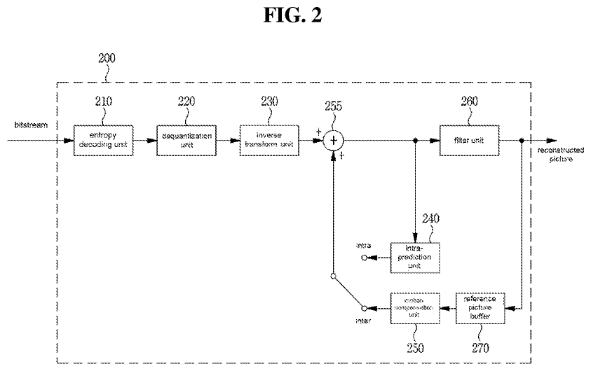

FIG. 1 is a block diagram showing a configuration of an encoding apparatus according to an embodiment to which the present invention is applied.

An encoding apparatus 100 may be an encoder, a video encoding apparatus, or an image encoding apparatus. A video may include at least one image. The encoding apparatus 100 may sequentially encode at least one image.

Referring to FIG. 1, the encoding apparatus 100 may include a motion prediction unit 111, a motion compensation unit 112, an intra-prediction unit 120, a switch 115, a subtractor 125, a transform unit 130, a quantization unit 140, an entropy encoding unit 150, a dequantization unit 160, a inverse-transform unit 170, an adder 175, a filter unit 180, and a reference picture buffer 190.

The encoding apparatus 100 may perform encoding of an input image by using an intra mode or an inter mode or both. In addition, encoding apparatus 100 may generate a bitstream through encoding the input image, and output the generated bitstream. The generated bitstream may be stored in a computer readable recording medium, or may be streamed through a wired/wireless transmission medium. When an intra mode is used as a prediction mode, the switch 115 may be switched to an intra. Alternatively, when an inter mode is used as a prediction mode, the switch 115 may be switched to an inter mode. Herein, the intra mode may mean an intra-prediction mode, and the inter mode may mean an inter-prediction mode. The encoding apparatus 100 may generate a prediction block for an input block of the input image. In addition, the encoding apparatus 100 may encode a residual of the input block and the prediction block after the prediction block being generated. The input image may be called as a current image that is a current encoding target. The input block may be called as a current block that is current encoding target, or as an encoding target block.

When a prediction mode is an intra mode, the intra-prediction unit 120 may use a pixel value of a block that has been already encoded/decoded and is adjacent to a current block as a reference pixel. The intra-prediction unit 120 may perform spatial prediction by using a reference pixel, or generate prediction samples of an input block by performing spatial prediction. Herein, the intra prediction may mean intra-prediction,

When a prediction mode is an inter mode, the motion prediction unit 111 may retrieve a region that best matches with an input block from a reference image when performing motion prediction, and deduce a motion vector by using the retrieved region. The reference image may be stored in the reference picture buffer 190.

The motion compensation unit 112 may generate a prediction block by performing motion compensation using a motion vector. Herein, inter-prediction may mean inter-prediction or motion compensation.

When the value of the motion vector is not an integer, the motion prediction unit 111 and the motion compensation unit 112 may generate the prediction block by applying an interpolation filter to a partial region of the reference picture. In order to perform inter-picture prediction or motion compensation on a coding unit, it may be determined that which mode among a skip mode, a merge mode, an advanced motion vector prediction (AMVP) mode, and a current picture referring mode is used for motion prediction and motion compensation of a prediction unit included in the corresponding coding unit. Then, inter-picture prediction or motion compensation may be differently performed depending on the determined mode.

The subtractor 125 may generate a residual block by using a residual of an input block and a prediction block. The residual block may be called as a residual signal. The residual signal may mean a difference between an original signal and a prediction signal. In addition, the residual signal may be a signal generated by transforming or quantizing, or transforming and quantizing a difference between the original signal and the prediction signal. The residual block may be a residual signal of a block unit.

The transform unit 130 may generate a transform coefficient by performing transform of a residual block, and output the generated transform coefficient. Herein, the transform coefficient may be a coefficient value generated by performing transform of the residual block. When a transform skip mode is applied, the transform unit 130 may skip transform of the residual block.

A quantized level may be generated by applying quantization to the transform coefficient or to the residual signal. Hereinafter, the quantized level may be also called as a transform coefficient in embodiments.

The quantization unit 140 may generate a quantized level by quantizing the transform coefficient or the residual signal according to a parameter, and output the generated quantized level. Herein, the quantization unit 140 may quantize the transform coefficient by using a quantization matrix.

The entropy encoding unit 150 may generate a bitstream by performing entropy encoding according to a probability distribution on values calculated by the quantization unit 140 or on coding parameter values calculated when performing encoding, and output the generated bitstream. The entropy encoding unit 150 may perform entropy encoding of pixel information of an image and information for decoding an image. For example, the information for decoding the image may include a syntax element.

When entropy encoding is applied, symbols are represented so that a smaller number of bits are assigned to a symbol having a high chance of being generated and a larger number of bits are assigned to a symbol having a low chance of being generated, and thus, the size of bit stream for symbols to be encoded may be decreased. The entropy encoding unit 150 may use an encoding method for entropy encoding such as exponential Golomb, context-adaptive variable length coding (CAVLC), context-adaptive binary arithmetic coding (CABAC), etc. For example, the entropy encoding unit 150 may perform entropy encoding by using a variable length coding/code (VLC) table. In addition, the entropy encoding unit 150 may deduce a binarization method of a target symbol and a probability model of a target symbol/bin, and perform arithmetic coding by using the deduced binarization method, and a context model.

In order to encode a transform coefficient level, the entropy encoding unit 150 may change a two-dimensional block form coefficient into a one-dimensional vector form by using a transform coefficient scanning method.

A coding parameter may include information (flag, index, etc.) such as syntax element that is encoded in an encoder and signaled to a decoder, and information derived when performing encoding or decoding. The coding parameter may mean information required when encoding or decoding an image. For example, at least one value or a combination form of a unit/block size, a unit/block depth, unit/block partition information, unit/block partition structure, whether to partition of a quad-tree form, whether to partition of a binary-tree form, a partition direction of a binary-tree form (horizontal direction or vertical direction), a partition form of a binary-tree form (symmetric partition or asymmetric partition), an intra-prediction mode/direction, a reference sample filtering method, a prediction block filtering method, a prediction block filter tap, a prediction block filter coefficient, an inter-prediction mode, motion information, a motion vector, a reference picture index, a inter-prediction angle, an inter-prediction indicator, a reference picture list, a reference picture, a motion vector predictor candidate, a motion vector candidate list, whether to use a merge mode, a merge candidate, a merge candidate list, whether to use a skip mode, an interpolation filter type, an interpolation filter tab, an interpolation filter coefficient, a motion vector size, a presentation accuracy of a motion vector, a transform type, a transform size, information of whether or not a primary(first) transform is used, information of whether or not a secondary transform is used, a primary transform index, a secondary transform index, information of whether or not a residual signal is present, a coded block pattern, a coded block flag(CBF), a quantization parameter, a quantization matrix, whether to apply an intra loop filter, an intra loop filter coefficient, an intra loop filter tab, an intra loop filter shape/form, whether to apply a deblocking filter, a deblocking filter coefficient, a deblocking filter tab, a deblocking filter strength, a deblocking filter shape/form, whether to apply an adaptive sample offset, an adaptive sample offset value, an adaptive sample offset category, an adaptive sample offset type, whether to apply an adaptive in-loop filter, an adaptive in-loop filter coefficient, an adaptive in-loop filter tab, an adaptive in-loop filter shape/form, a binarization/inverse-binarization method, a context model determining method, a context model updating method, whether to perform a regular mode, whether to perform a bypass mode, a context bin, a bypass bin, a transform coefficient, a transform coefficient level, a transform coefficient level scanning method, an image displaying/outputting sequence, slice identification information, a slice type, slice partition information, tile identification information, a tile type, tile partition information, a picture type, a bit depth, and information of a luma signal or chroma signal may be included in the coding parameter.

Herein, signaling the flag or index may mean that a corresponding flag or index is entropy encoded and included in a bitstream by an encoder, and may mean that the corresponding flag or index is entropy decoded from a bitstream by a decoder.

When the encoding apparatus 100 performs encoding through inter-prediction, an encoded current image may be used as a reference image for another image that is processed afterwards. Accordingly, the encoding apparatus 100 may reconstruct or decode the encoded current image, or store the reconstructed or decoded image as a reference image.

A quantized level may be dequantized in the dequantization unit 160, or may be inverse-transformed in the inverse-transform unit 170. A dequantized or inverse-transformed coefficient or both may be added with a prediction block by the adder 175. By adding the dequantized or inverse-transformed coefficient or both with the prediction block, a reconstructed block may be generated. Herein, the dequantized or inverse-transformed coefficient or both may mean a coefficient on which at least one of dequantization and inverse-transform is performed, and may mean a reconstructed residual block.

A reconstructed block may pass through the filter unit 180. The filter unit 180 may apply at least one of a deblocking filter, a sample adaptive offset (SAO), and an adaptive loop filter (ALF) to the reconstructed block or a reconstructed image. The filter unit 180 may be called as an in-loop filter.

The deblocking filter may remove block distortion generated in boundaries between blocks. In order to determine whether or not to apply a deblocking filter, whether or not to apply a deblocking filter to a current block may be determined based pixels included in several rows or columns which are included in the block. When a deblocking filter is applied to a block, another filter may be applied according to a required deblocking filtering strength.

In order to compensate an encoding error, a proper offset value may be added to a pixel value by using a sample adaptive offset. The sample adaptive offset may correct an offset of a deblocked image from an original image by a pixel unit. A method of partitioning pixels of an image into a predetermined number of regions, determining a region to which an offset is applied, and applying the offset to the determined region, or a method of applying an offset in consideration of edge information on each pixel may be used.

The adaptive loop filter may perform filtering based on a comparison result of the filtered reconstructed image and the original image. Pixels included in an image may be partitioned into predetermined groups, a filter to be applied to each group may be determined, and differential filtering may be performed for each group. Information of whether or not to apply the ALF may be signaled by coding units (CUs), and a form and coefficient of the ALF to be applied to each block may vary.

The reconstructed block or the reconstructed image having passed through the filter unit 180 may be stored in the reference picture buffer 190. FIG. 2 is a block diagram showing a configuration of a decoding apparatus according to an embodiment and to which the present invention is applied.

A decoding apparatus 200 may a decoder, a video decoding apparatus, or an image decoding apparatus.

Referring to FIG. 2, the decoding apparatus 200 may include an entropy decoding unit 210, a dequantization unit 220, a inverse-transform unit 230, an intra-prediction unit 240, a motion compensation unit 250, an adder 225, a filter unit 260, and a reference picture buffer 270.

The decoding apparatus 200 may receive a bitstream output from the encoding apparatus 100. The decoding apparatus 200 may receive a bitstream stored in a computer readable recording medium, or may receive a bitstream that is streamed through a wired/wireless transmission medium. The decoding apparatus 200 may decode the bitstream by using an intra mode or an inter mode. In addition, the decoding apparatus 200 may generate a reconstructed image generated through decoding or a decoded image, and output the reconstructed image or decoded image.

When a prediction mode used when decoding is an intra mode, a switch may be switched to an intra. Alternatively, when a prediction mode used when decoding is an inter mode, a switch may be switched to an inter mode.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block with the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be a inverse-process of the entropy encoding method described above.

In order to decode a transform coefficient level, the entropy decoding unit 210 may change a one-directional vector form coefficient into a two-dimensional block form by using a transform coefficient scanning method.

A quantized level may be dequantized in the dequantization unit 220, or inverse-transformed in the inverse-transform unit 230. The quantized level may be a result of dequantizing or inverse-transforming or both, and may be generated as a reconstructed residual block. Herein, the dequantization unit 220 may apply a quantization matrix to the quantized level.

When an intra mode is used, the intra-prediction unit 240 may generate a prediction block by performing spatial prediction that uses a pixel value of a block adjacent to a decoding target block and which has been already decoded.

When an inter mode is used, the motion compensation unit 250 may generate a prediction block by performing motion compensation that uses a motion vector and a reference image stored in the reference picture buffer 270.

The adder 225 may generate a reconstructed block by adding the reconstructed residual block with the prediction block. The filter unit 260 may apply at least one of a deblocking filter, a sample adaptive offset, and an adaptive loop filter to the reconstructed block or reconstructed image. The filter unit 260 may output the reconstructed image. The reconstructed block or reconstructed image may be stored in the reference picture buffer 270 and used when performing inter-prediction.

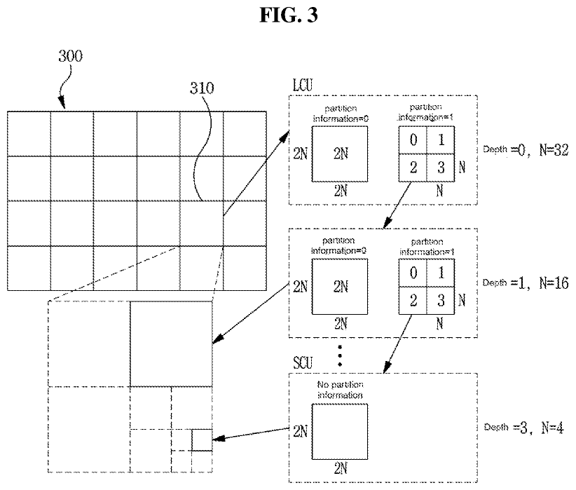

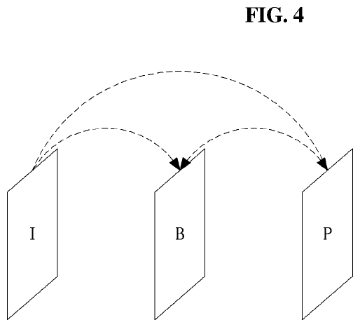

FIG. 3 is a view schematically showing a partition structure of an image when encoding and decoding the image. FIG. 3 schematically shows an example of partitioning a single unit into a plurality of lower units.

In order to efficiently partition an image, when encoding and decoding, a coding unit (CU) may be used. The coding unit may be used as a basic unit when encoding/decoding the image. In addition, the coding unit may be used as a unit for distinguishing an intra mode and an inter mode when encoding/decoding the image. The coding unit may be a basic unit used for prediction, transform, quantization, inverse-transform, dequantization, or an encoding/decoding process of a transform coefficient.

Referring to FIG. 3, an image 300 is sequentially partitioned in a largest coding unit (LCU), and a LCU unit is determined as a partition structure. Herein, the LCU may be used in the same meaning as a coding tree unit (CTU). A unit partitioning may mean partitioning a block associated with to the unit. In block partition information, information of a unit depth may be included. Depth information may represent a number of times or a degree or both in which a unit is partitioned. A single unit may be partitioned in a layer associated with depth information based on a tree structure. Each of partitioned lower unit may have depth information. Depth information may be information representing a size of a CU, and may be stored in each CU.

A partition structure may mean a distribution of a coding unit (CU) within an LCU 310. Such a distribution may be determined according to whether or not to partition a single CU into a plurality (positive integer equal to or greater than 2 including 2, 4, 8, 16, etc.) of CUs. A horizontal size and a vertical size of the CU generated by partitioning may respectively be half of a horizontal size and a vertical size of the CU before partitioning, or may respectively have sizes smaller than a horizontal size and a vertical size before partitioning according to a number of times of partitioning. The CU may be recursively partitioned into a plurality of CUs. Partitioning of the CU may be recursively performed until to a predefined depth or predefined size. For example, a depth of an LCU may be 0, and a depth of a smallest coding unit (SCU) may be a predefined maximum depth. Herein, the LCU may be a coding unit having a maximum coding unit size, and the SCU may be a coding unit having a minimum coding unit size as described above. Partitioning is started from the LCU 310, a CU depth increases by 1 as a horizontal size or a vertical size or both of the CU decreases by partitioning.

In addition, information whether or not the CU is partitioned may be represented by using partition information of the CU. The partition information may be 1-bit information. All CUs, except for a SCU, may include partition information. For example, when a value of partition information is 1, the CU may not be partitioned, when a value of partition information is 2, the CU may be partitioned.

Referring to FIG. 3, an LCU having a depth 0 may be a 64×64 block. 0 may be a minimum depth. A SCU having a depth 3 may be an 8×8 block. 3 may be a maximum depth. A CU of a 32×32 block and a 16×16 block may be respectively represented as a depth 1 and a depth 2.

For example, when a single coding unit is partitioned into four coding units, a horizontal size and a vertical size of the four partitioned coding units may be a half size of a horizontal and vertical size of the CU before being partitioned. In one embodiment, when a coding unit having a 32×32 size is partitioned into four coding units, each of the four partitioned coding units may have a 16×16 size. When a single coding unit is partitioned into four coding units, it may be called that the coding unit may be partitioned into a quad-tree form.

For example, when a single coding unit is partitioned into two coding units, a horizontal or vertical size of the two coding units may be a half of a horizontal or vertical size of the coding unit before being partitioned. For example, when a coding unit having a 32×32 size is partitioned in a vertical direction, each of two partitioned coding units may have a size of 16×32. When a single coding unit is partitioned into two coding units, it may be called that the coding unit is partitioned in a binary-tree form. An LCU 320 of FIG. 3 is an example of an LCU to which both of partitioning of a quad-tree form and partitioning of a binary-tree form are applied.

FIG. 4 is a diagram illustrating an embodiment of an inter-picture prediction process.

In FIG. 4, a rectangle may represent a picture. In FIG. 4, an arrow represents a prediction direction. Pictures may be categorized into intra pictures (I pictures), predictive pictures (P pictures), and Bi-predictive pictures (B pictures) according to the encoding type thereof.

The I picture may be encoded through intra-prediction without requiring inter-picture prediction. The P picture may be encoded through inter-picture prediction by using a reference picture that is present in one direction (i.e., forward direction or backward direction) with respect to a current block. The B picture may be encoded through inter-picture prediction by using reference pictures that are preset in two directions (i.e., forward direction and backward direction) with respect to a current block. When the inter-picture prediction is used, the encoder may perform inter-picture prediction or motion compensation and the decoder may perform the corresponding motion compensation.

Hereinbelow, an embodiment of the inter-picture prediction will be described in detail.

The inter-picture prediction or motion compensation may be performed using a reference picture and motion information.

Motion information of a current block may be derived during inter-picture prediction by each of the encoding apparatus 100 and the decoding apparatus 200. The motion information of the current block may be derived by using motion information of a reconstructed neighboring block, motion information of a collocated block (also referred to as a col block or a co-located block), and/or a block adjacent to the co-located block. The co-located block may mean a block that is located spatially at the same position as the current block, within a previously reconstructed collocated picture (also referred to as a col picture or a co-located picture). The co-located picture may be one picture among one or more reference pictures included in a reference picture list.

A method of deriving the motion information of the current block may vary depending on a prediction mode of the current block. For example, as prediction modes for inter-picture prediction, there may be an AMVP mode, a merge mode, a skip mode, a current picture reference mode, etc. The merge mode may be referred to as a motion merge mode.

For example, when the AMVP is used as the prediction mode, at least one of motion vectors of the reconstructed neighboring blocks, motion vectors of the co-located blocks, motion vectors of blocks adjacent to the co-located blocks, and a (0, 0) motion vector may be determined as motion vector candidates for the current block, and a motion vector candidate list is generated by using the emotion vector candidates. The motion vector candidate of the current block can be derived by using the generated motion vector candidate list. The motion information of the current block may be determined based on the derived motion vector candidate. The motion vectors of the collocated blocks or the motion vectors of the blocks adjacent to the collocated blocks may be referred to as temporal motion vector candidates, and the motion vectors of the reconstructed neighboring blocks may be referred to as spatial motion vector candidates.

The encoding apparatus 100 may calculate a motion vector difference (MVD) between the motion vector of the current block and the motion vector candidate and may perform entropy encoding on the motion vector difference (MVD). In addition, the encoding apparatus 100 may perform entropy encoding on a motion vector candidate index and generate a bitstream. The motion vector candidate index may indicate an optimum motion vector candidate among the motion vector candidates included in the motion vector candidate list. The decoding apparatus may perform entropy decoding on the motion vector candidate index included in the bitstream and may select a motion vector candidate of a decoding target block from among the motion vector candidates included in the motion vector candidate list by using the entropy-decoded motion vector candidate index. In addition, the decoding apparatus 200 may add the entropy-decoded MVD and the motion vector candidate extracted through the entropy decoding, thereby deriving the motion vector of the decoding target block.

The bitstream may include a reference picture index indicating a reference picture. The reference picture index may be entropy-encoded by the encoding apparatus 100 and then signaled as a bitstream to the decoding apparatus 200. The decoding apparatus 200 may generate a prediction block of the decoding target block based on the derived motion vector and the reference picture index information.

Another example of the method of deriving the motion information of the current may be the merge mode. The merge mode may mean a method of merging motion of a plurality of blocks. The merge mode may mean a mode of deriving the motion information of the current block from the motion information of the neighboring blocks. When the merge mode is applied, the merge candidate list may be generated using the motion information of the reconstructed neighboring blocks and/or the motion information of the collocated blocks. The motion information may include at least one of a motion vector, a reference picture index, and an inter-picture prediction indicator. The prediction indicator may indicate one-direction prediction (L0 prediction or L1 prediction) or two-direction predictions (L0 prediction and L1 prediction).

The merge candidate list may be a list of motion information stored. The motion information included in the merge candidate list may be at least either one of the zero merge candidate and new motion information that is a combination of the motion information (spatial merge candidate) of one neighboring block adjacent to the current block, the motion information (temporal merge candidate) of the collocated block of the current block, which is included within the reference picture, and the motion information exiting in the merge candidate list.

The encoding apparatus 100 may generate a bitstream by performing entropy encoding on at least one of a merge flag and a merge index and may signal the bitstream to the decoding apparatus 200. The merge flag may be information indicating whether or not to perform the merge mode for each block, and the merge index may be information indicating that which neighboring block, among the neighboring blocks of the current block, is a merge target block. For example, the neighboring blocks of the current block may include a left neighboring block on the left side of the current block, an upper neighboring block disposed above the current block, and a temporal neighboring block temporally adjacent to the current block.

The skip mode may be a mode in which the motion information of the neighboring block is applied to the current block as it is. When the skip mode is applied, the encoding apparatus 100 may perform entropy encoding on information of the fact that the motion information of which block is to be used as the motion information of the current block to generate a bit stream, and may signal the bitstream to the decoding apparatus 200. The encoding apparatus 100 may not signal a syntax element regarding at least any one of the motion vector difference information, the encoding block flag, and the transform coefficient level to the decoding apparatus 200.

The current picture reference mode may mean a prediction mode in which a previously reconstructed region within a current picture to which the current block belongs is used for prediction. Here, a vector may be used to specify the previously-reconstructed region. Information indicating whether the current block is to be encoded in the current picture reference mode may be encoded by using the reference picture index of the current block. The flag or index indicating whether or not the current block is a block encoded in the current picture reference mode may be signaled, and may be deduced based on the reference picture index of the current block. In the case where the current block is encoded in the current picture reference mode, the current picture may be added to the reference picture list for the current block so as to be located at a fixed position or a random position in the reference picture list. The fixed position may be, for example, a position indicated by a reference picture index of 0, or the last position in the list. When the current picture is added to the reference picture list so as to be located at the random position, the reference picture index indicating the random position may be signaled.

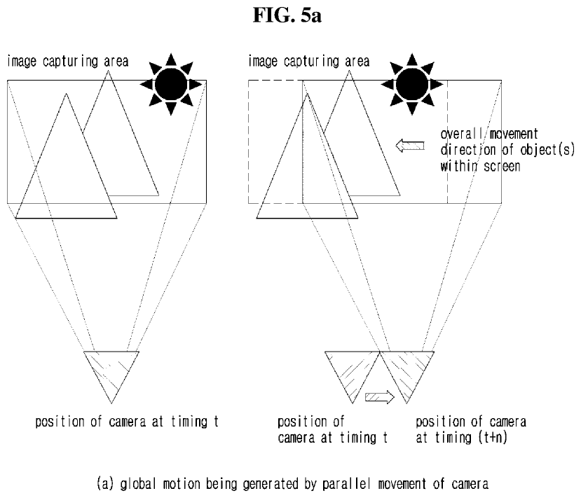

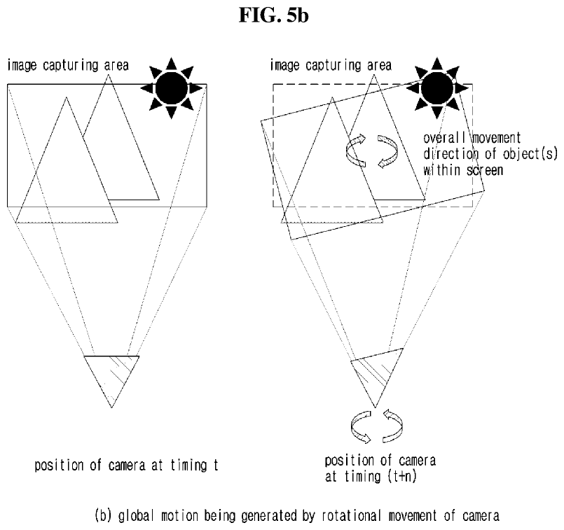

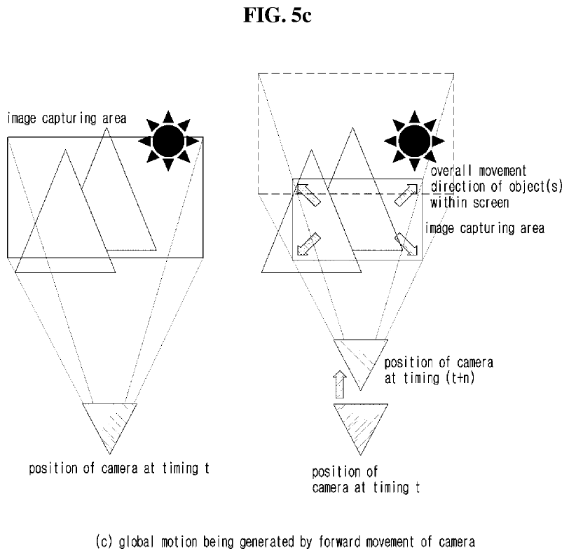

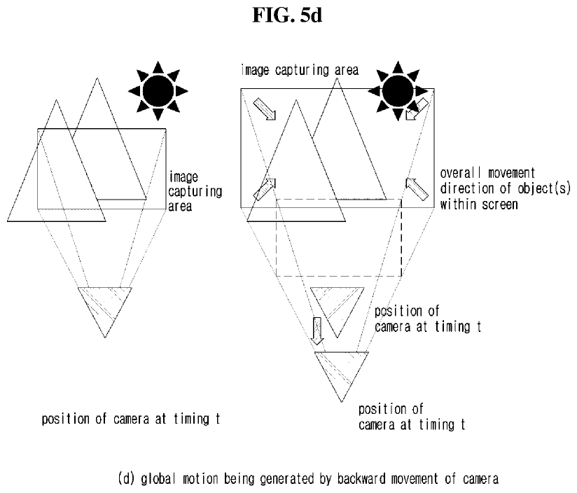

Hereinafter, image encoding/decoding methods using global motion information according to the present invention will be described with reference to FIGS. 5 to 15.

A video includes global motions and local motions according to a time flow within the video. A global motion may refer to a motion having tendency which is included in the entire image. The global motion may be generated by a camera work or common motion across the entire captured area. Herein, the global motion may be a concept of including a global motion, and the local motion may be a concept of including a local motion. Accordingly, in the present description, the global motion may be called a global motion, global motion information may be called global motion information, the local motion may be called a local motion, and local motion information may be called local motion information.

In addition, in the present description, a frame may be called a picture, a reference frame may be called a reference picture, and a current frame may be called a current picture.

FIG. 5 is a view for illustrating a generation example of a global motion.

Referring to FIG. 5, when camera work by a parallel movement is used as shown in FIG. 5a, most of objects within an image include (carries) parallel motions in a specific direction.

When camera work that rotates a camera capturing images is used as shown in FIG. 5b, most of objects within an image include (carries) motions that rotate in a specific direction.

When a camera work that forwardly moves the camera is used as shown in FIG. 5c, a motion in which objects within an image are scaled up is shown.

When a camera work that backwardly moves the camera is used as shown in FIG. 5d, a motion in which objects within an image are scaled down is shown.

A local motion may mean a case when an image includes a motion different from the global motion within the image. This may refer to a case including an additional motion while including a global motion, or may be a case including a motion completely different from the global motion.

For example, when most objects within an image move in a left direction due to the image using a panning method, and an object moving in an opposite direction may mean that the object includes a local motion.

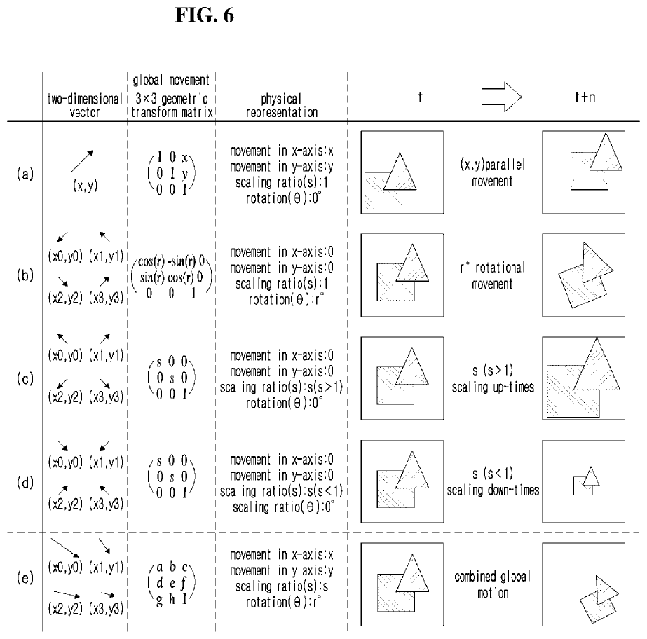

FIG. 6 is a view for illustrating an example method of representing a global motion of an image.

FIG. 6(a) shows a method of representing a global motion generated by a parallel movement. A two-dimensional vector is represented in two values: an x variable meaning a parallel movement in an x-axis; and a y variable meaning a parallel movement in a y-axis. When a global motion generated by a parallel movement is represented in a 3×3 geometric transform matrix, among nine variables, only two variables have values in which the parallel movement is reflected, and remaining seven values have fixed values. When four variables representing an x-axial movement, a y-axial movement, a scaling up/down (scaling ratio), and a rotation are represented in a physical representing method of representing a global motion of an image, among four variables, variables of an x-axial movement and a y-axial movement which represent a parallel movement may have values in which the parallel movement is reflected, a scaling ratio variable may be 1 since there is no scaling up/down. In addition, since there was no rotation, a rotation variable may be represented to have a rotation angle being 0 degree.

FIG. 6(b) shows a method of representing a global motion generated by a rotation motion. A rotation movement may not be represented by using a single two-dimensional vector. In FIG. 6(b), four two-dimensional vectors are used for representing a rotation movement, when a large number of two-dimensional vectors is used, a rotation movement may be represented more accurately. However, when a large number of two-dimensional vectors is used, an additional information amount used for representing a global motion increases so that coding efficiency decreases. Accordingly, there is a need for using a proper number of two-dimensional vectors in consideration of prediction accuracy and an additional information amount. In addition, a global motion reflecting each detailed area may be calculated by using two-dimensional motion vectors used for representing a global motion, and the calculated global motion may be used. When a global motion generated by a rotation movement is represented in a 3×3 geometric transform matrix, among nine variables, four variables have values in which the rotation movement is reflected, and the remaining five variables have fixed values. Herein, the four variables in which the rotation movement is reflected are represented by cosine and sine functions rather than a rotation angle. When the four variables representing an x-axial movement, a y-axial movement, a scaling up/down (scaling ratio), and a rotation (angle) are represented by a physical representation method that represents a global motion of an image, among four variables, a rotation variable representing the rotation movement has a value in which the rotation movement is reflected, and a scaling ratio is 1 since there is no scaling up/down. In addition, it is represented that there is no movement by representing an x-axial movement and a y-axial movement to have values being 0 since there is no parallel movement.

FIG. 6(c) represents a global motion generated by a scaling up, and FIG. 6(d) represents a global motion generated by a scaling down. Similarly to a rotation movement, scaling up/down movements may not be represented by using a single two-dimensional vector. Accordingly, similarly to a rotation movement, information of a number of two-dimensional vectors may be used. Examples of FIGS. 6(c) and 6(d) are represented by using four two-dimensional vectors. When each global motion generated by scaling up/down is represented in a 3×3 geometric transform matrixes, among nine variables, two variables have values in which the scaling up/down is reflected. Herein, each variable may be divided into an x-axial scaling up/down ratio and a y-axial scaling up/down ratio. An example of FIG. 6 shows cases when the x-axial scaling up/down ratio and the y-axial scaling up/down ratio are identical. When four variables representing an x-axial movement, a y-axial movement, a scaling up/down (scaling ratio), and a rotation (angle) are represented in a physical representation method that represents a global motion of an image, among four variables, a scaling ratio variable representing a scaling up/down has a value in which the scaling up/down is reflected, and remaining values have values that are constant. Herein, since a single scaling ratio variable is present, a case in which the entire image has a constant scaling ratio may be represented. In order to separately represent the x-axial scaling ratio and the y-axial scaling ratio, two scaling ratio variables are required.

FIG. 6(e) is an example of a global motion when a parallel movement, a rotation, and a scaling up/down are generated at the same time. Since a rotation and a scaling down are reflected, the global motion may not be represented by using a single two-dimensional vector. Accordingly, global motion may be represented by using a plurality of two-dimensional vectors. When a 3×3 geometric transform matrix is used, among nine variables, eight variables are used for representing the global motion. Herein, each variable of the matrix represents a combination of a complex and continuous global motion, thus it may be difficult to describe which motion is reflected by which variable. In addition, when eight variables of the 3×3 matrix are used, a global motion generated by a perspective transform that is not included in an example of FIG. 6(e) may be represented. When four variables representing an x-axial movement, a y-axial movement, a scaling up/down (scaling ratio), a rotation (angle) are represented in a physical representation method that represents a global motion of an image, four variables are used to represent respective motions.

When a global motion is represented by using a two-dimensional motion vector, two variables are used just in case for representing a parallel movement, thus the global motion may be represented with a few amount of additional information. When representing a global motion that is more complicated than a global motion including a rotation, a scaling down, etc., it becomes difficult to accurately represent the global motion, and a large amount of additional information is used for accurately representing the same. Accordingly, coding efficiency may decrease.

When a 3×3 geometric transform matrix is used, a global motion may be represented very accurately. In general, eight variable values, except for a single constant variable, are required, thus coding efficiency may decrease since the global motion is represented by using a large amount of additional information.

When a physical representation method is used, a necessary global motion may be selectively used. However, there is a limit to precisely represent the global motion than by using a 3×3 geometric transform matrix. In order to compensate the same, a large number of variables may be used. For example, when the center of a rotation or a scaling up/down is not the center of an image, variables representing the central position may be added since there is a limit of representing by using the physical representation method of FIG. 6.

In order to improve encoding performance, the image encoder and decoder may use a method that maximally excludes an image redundancy. In a method of excluding an image redundancy, in order to accurately exclude redundant information, motions of objects within the image may be predicted and used. Herein, in general, a motion prediction is performed by dividing the image into areas

In one embodiment, in HEVC/H.265, an image is used by being divided into a square or rectangle shape such as coding unit, prediction unit, and the shape also includes a macro block.

This is for considering various local motions within the image, and also for performing a motion prediction more precisely. During the process, information representing a motion of each area is generated, generated local motion information is encoded and additionally included in a bitstream, and the additional included local motion information occupies a large number of bits within the bitstream. For the above mentioned reasons, local motion information may be predicted and used by being compressed using an entropy coding method.

In addition, since the local motion information generated as above generally includes a global motion, in order to compress the local motion information, a method of using global motion information that is overall tendency included in the local motion information is present. By representing the global motion, the local motion may be represented by representing a difference with the global motion. When the local motion includes a number of global motions, the difference therebetween becomes small, thus a symbol amount to be represented may decrease.

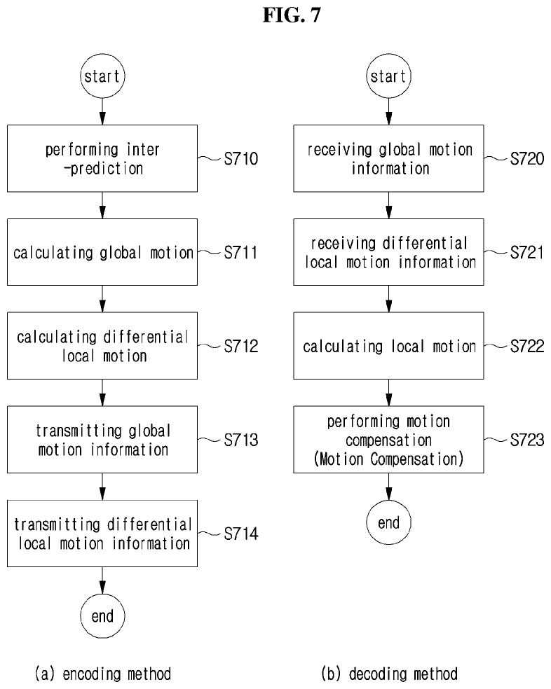

FIG. 7 is a flowchart for illustrating encoding method and decoding methods of using global motion information.

Referring to FIG. 7, in step S710, a local motion may be determined by performing inter-prediction, and in step S711, a global motion may be calculated. Then, in step S712, the local motion and the global motion may be separated by excluding the global motion included in the local motion by using differences between individual local motions and the calculated global motion. Accordingly, in steps S713 and S714, calculated differential local motion information and global motion information may be transmitted. In steps S720 and S721, a decoder may receive global motion information and differential local motion information, and in step S722, original individual local motion information may be reconstructed by using the information. Then, in step S723, the decoder may perform motion compensation by using the reconstructed local motion.

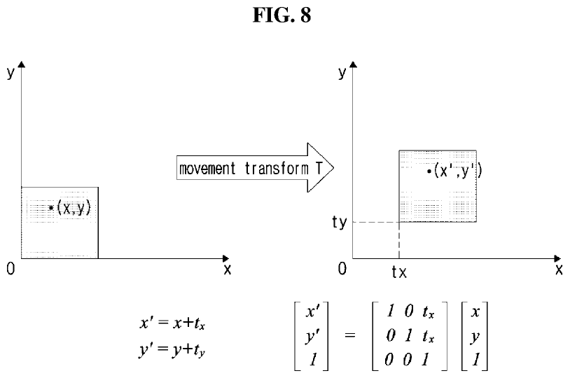

FIGS. 8 to 12 are views for illustrating examples of a geometric transform of an image to represent a global motion.

In a video coding method reflecting a global motion, a coding method using an image geometric transform may be present. The image geometric transform means modifying an image by reflecting a geometric motion to a position of pixel information included in the image.

Pixel information may mean a luminance value of each point of an image, and may mean a color and a chroma. In addition, the pixel information may mean a pixel value in a digital image. A geometric modification may mean a parallel movement, a rotation, a size change of each point including pixel information within an image, and may be used for representing global motion information.

In FIGS. 8 to 12, (x,y) may mean a point of an original image to which transform is not applied, (x′,y′) may mean a point corresponding to (x,y) within an image to which transform is applied. Herein, the corresponding point may mean a point generated by moving (x,y) by transforming luma information thereof.

FIG. 8 is a view showing a transform example when each point of an image moves in parallel. tx means a movement displacement of each point in an x-axis, and ty means a movement displacement of each point in a y-axis. Accordingly, a moved point (x′,y′) may be determined by adding tx and ty to each point (x,y) of the image. The above movement transform may be represented in a determinant of FIG. 8.

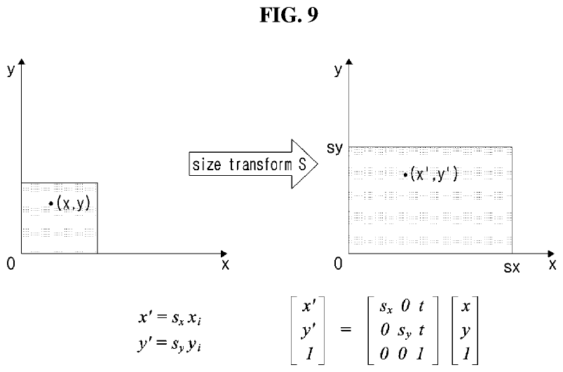

FIG. 9 is a view showing an image transform example generated by a size modification. sx means a scaling ratio in an x-axial size modification, and sy means a scaling ratio in a y-axial size modification. A scaling ratio in a size modification being 1 means that the modified size of the image is identical to an original size. When the scaling ratio in the size modification is greater than 1, it means that the image is scaled up, and when the scaling ratio of the size modification is smaller than 1, it means that the image is scaled down. In addition, the scaling ratio in the size modification has a value being always greater than 0. Accordingly, a size modified point (x′,y′) may be determined by multiplying each point (x,y) of the image by sx and sy. A size transform may be represented in a determinant of FIG. 9.

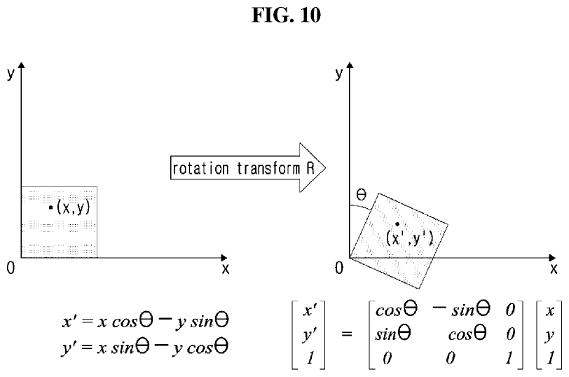

FIG. 10 is a view showing an image transform example generated by a rotation modification. Θ means a rotation angle of an image. The example of FIG. 10 shows a rotation based on a (0,0) point of the image. By using 8 and a trigonometrical function, a rotated point of the image may be calculated. This may be represented in a determinant of FIG. 10.

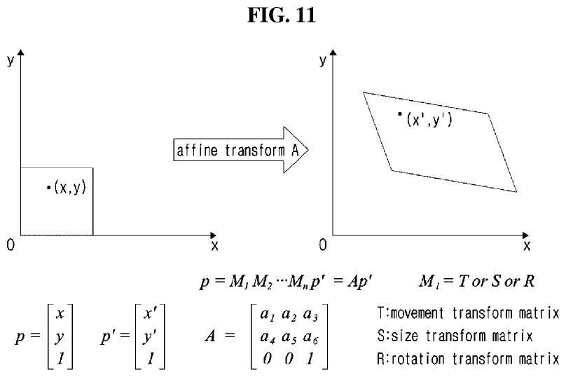

FIG. 11 is a view showing an example of an affine transform. The affine transform means a case in which a movement transform, a size transform, and a rotation transform are in combination. A geometric transform form by an affine transform may vary according to an order of each of a movement transform, a size transform, and a rotation transform. According to a transform order and a combination thereof, a modification form in which an image area is inclined may be obtained in addition to the movement, size modification, and rotation transform. M of FIG. 11 may have a 3×3 matrix form, and may be one of a movement geometric transform matrix, a size geometric transform matrix, and a rotation geometric transform matrix. Such a combined matrix may be represented in a single 3×3 matrix form by using a matrix multiplication, and represented in a form of a matrix A of FIG. 11. a1˜a6 means elements of the matrix A. p means an arbitrary point of an original image represented by the matrix, and p′ means a point of a geometric transformed image and which corresponds to the point p of the original image represented by the matrix. Accordingly, the affine transform may be represented in a determinant form of p=Ap′.

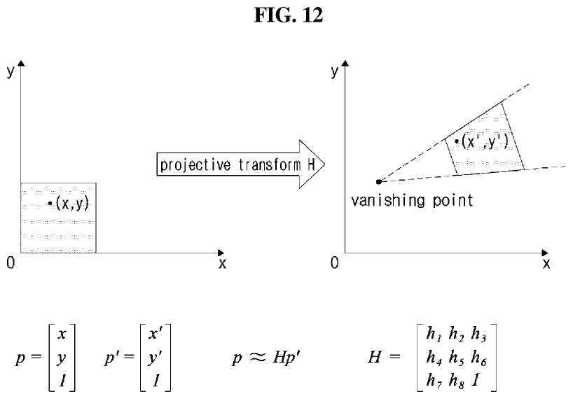

FIG. 12 is a view showing an example of a projective transform. The projective transform may be an extended transform method to which an affine transform form and a perspective modification is applied. When an object of a three-dimensional space is projected on a two-dimensional planar surface, according to a viewing angle of a camera or observer, a perspective modification is applied. The perspective modification refers to an object being far away appearing to be small, and a nearby object appearing to be large. The projective transform may be a form in which a perspective modification is additionally considered in an affine transform. A matrix representing the projective transform is H shown in FIG. 12. Values of h1˜h6 elements constituting the H correspond to a1˜a6 of the affine transform of FIG. 12 thereby the projective transform includes the affine transform. h7 and h8 are elements for considering the perspective transform.

Video coding using an image geometric transform is a video coding method using additional information that is generated by an image geometric transform of an inter-prediction method using motion information. Additional information (or geometric transform information) may refer to all kinds of information that enables easy prediction of a reference image or a partial area of the reference image, and an image for which prediction is performed by using the reference image or a partial area thereof. In one embodiment, the information may be a global motion vector, an affine geometric transform matrix, a projective geometric transform matrix, etc. In addition, the geometric transform information may include global motion information.

By using geometric transform information, image coding efficiency that is degraded due to a conventional method such as rotation, scaling up/down of an image may be improved. An encoder may analyze a relationship between a current frame and a reference frame, generate geometric transform information that transforms the reference frame to a form close to the current frame by using the analyzed relationship, and generate an additional reference frame (transform frame).

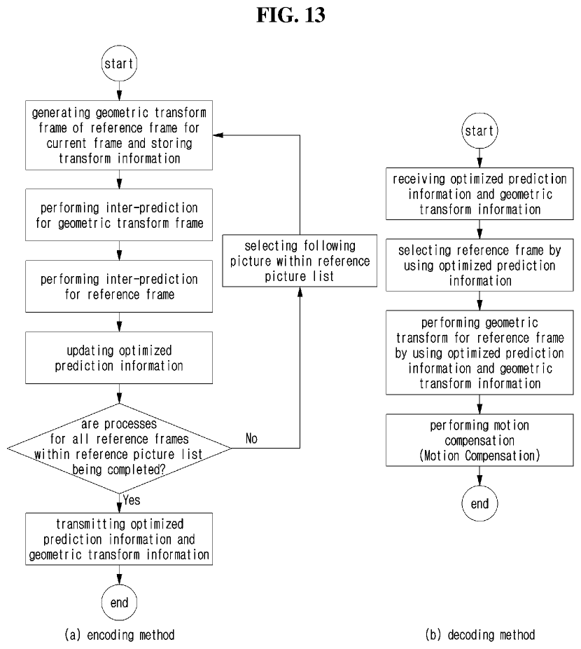

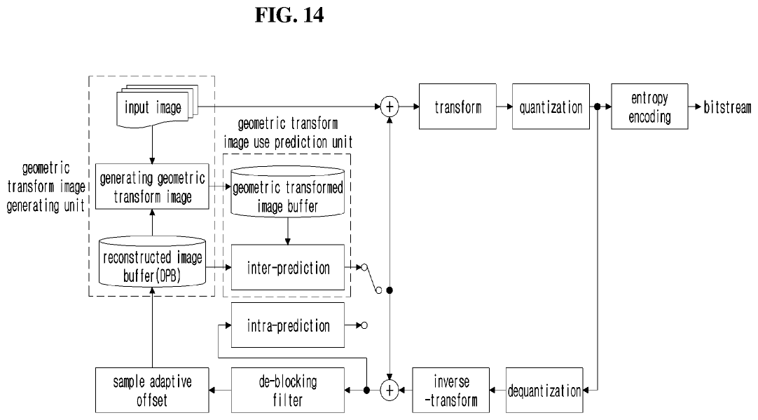

Optimized coding efficiency may be obtained by using both of a reference frame for which a modification process is performed during inter-prediction, and an original reference frame. Examples of encoding and decoding methods using an image geometric transform are as shown in FIG. 13, and an example of an encoding apparatus using an image geometric transform is as shown in FIG. 14.

As a result, motion information and selected reference frame information may be obtained. Herein, the selected reference frame information may include an index value capable of distinguishing the selected reference frame among a plurality of reference frames, and a value indicating whether or not the selected reference frame is a geometric transformed reference frame. The above information may be transmitted in various units. For example, when the information is applied to a block unit prediction structure used in HEVC codec, the information may be transmitted in a coding unit (hereinafter, ‘CU’), or a prediction unit (hereinafter, ‘PU’).

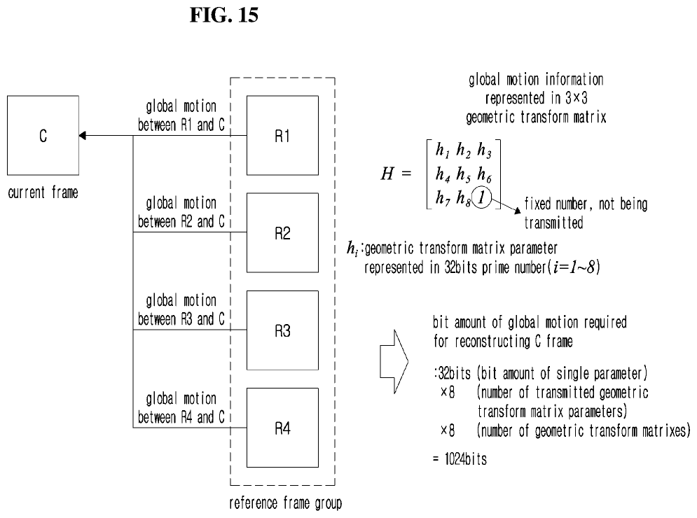

FIG. 15 is a view for illustrating an example of representing a global motion that requires a large number of bits.

Referring to FIG. 15, in order to represent global motions between a current frame (C) and reference frames (R1, R2, R3, and R4), the global motions may be represented in a 3×3 geometric transform matrix. Herein, a single parameter may have a bit amount of 32 bits, a number of parameters transmitted in a geometric transform matrix may be eight.

Herein, a bit amount of global motion information required for reconstructing the current frame (C) may be calculated as 1024 bits.

In other words, when global motion information is used for all reference frames of the current frame, the global motion information may occupy a large number of bits within a bitstream.

Based on the above description, a method of selectively omitting global motion information according to the present invention will be described in detail.

In the present invention, when coding efficiency using global motion information of encoding and decoding a current frame is not larger than loss due to additional information generated by using global motion information, there is purposed a method of omitting or reducing a transmission of the global motion information to improve coding efficiency. Herein, information included in a reference frame refers to a group of reference information including image pixel information, motion information, prediction information, etc. which are required for encoding and decoding the current frame. In addition, the information included in the reference frame may include global motion information.

Herein, the motion information of the reference frame may represent a relationship between a third reference frame used for reconstructing the corresponding reference frame and the reference frame.

In the present invention, coding efficiency may be improved by selectively omitting a use of global motion information in encoding and decoding methods or apparatuses using global motion information.

When a global motion is used during video encoding and decoding, additional information representing the global motion, and additional information for using or predicting the global motion may be required in the decoder.

Herein, the additional information of the global motion may occupy a large number of bits within a bitstream, thus coding efficiency may be degraded.

Accordingly, when it is predicted that usage efficiency of global motion information is not good or to be not good, coding efficiency may be improved by omitting the use of the global motion information.

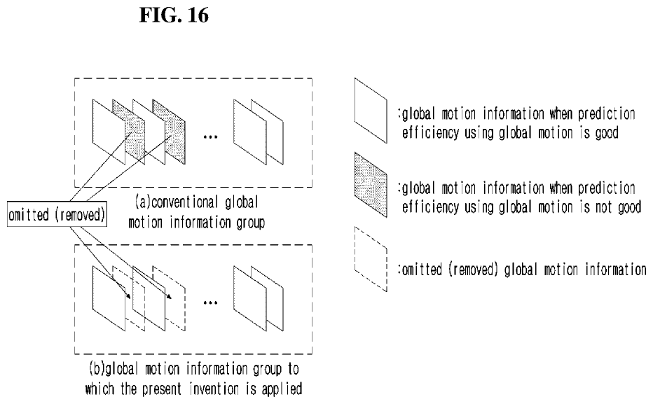

FIG. 16 is a view for illustrating a method of omitting global motion information.

Referring to FIG. 16, when global motion information is present as shown in FIG. 16(a), the global motion information is configured as shown in FIG. 16 (b) by omitting (removing) global motion information having global motion prediction efficiency being bad. Accordingly, an amount of global motion information to be transmitted may be reduced. Herein, inter-prediction using a global motion in which global motion information is omitted may be changed to inter-prediction without using the global motion.

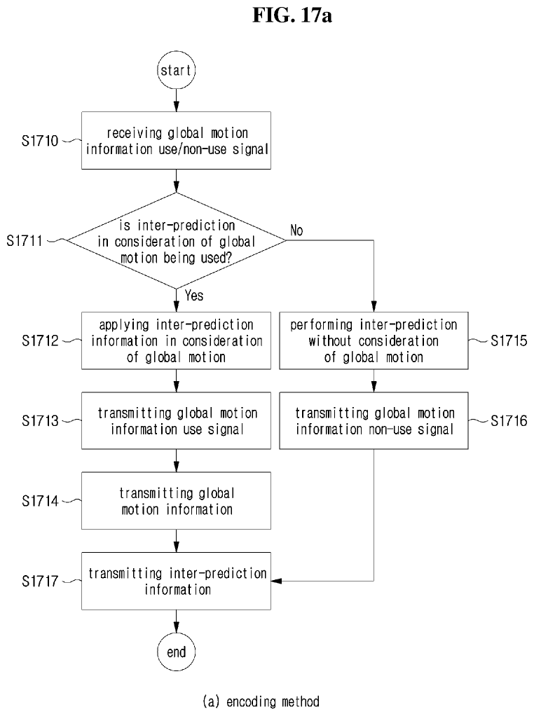

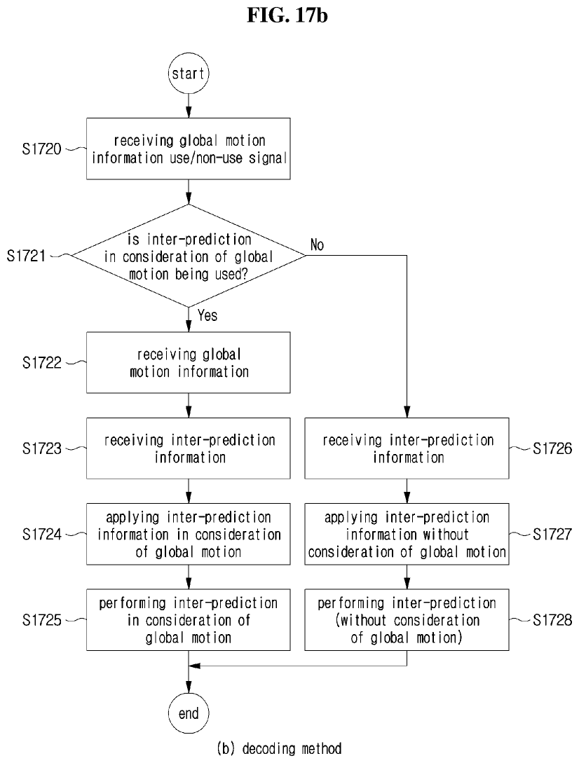

FIG. 17 is a flowchart showing an example of encoding and decoding methods using a method of selectively omitting global motion information.

FIG. 17a is a flowchart showing an example of an encoding method using a method of selectively omitting global motion information.

Referring to FIG. 17a, in step S1710, whether or not to use a global motion may be determined. When the global motion is used (S1711—YES), in step S1712, inter-prediction in consideration of the global motion is performed. Then, in steps S1713, S1714, and S1717, a global motion information use signal, and inter-prediction information including global motion information may be transmitted. Alternatively, when the global motion is not used (S1711—NO), in step S1715, inter-prediction without consideration of the global motion is performed. Then, in steps S1716 and S1717, a global motion non-use signal, and inter-prediction information not including global motion information may be transmitted.

Herein, the global motion information use signal and the global motion information non-use signal may be global motion information use/non-use information having a flag or index form.

FIG. 17b is a flowchart showing an example of a decoding method using a method of selectively omitting global motion information.

Referring to FIG. 17b, in step S1720, a global motion use/non-use signal may be received, and in step S1721, whether or not to use a global motion may be determined. When the global motion is used (S1721—YES), in steps S1722 and S1723, inter-prediction may be performed in consideration of the global motion by receiving inter-prediction information including global motion information. Alternatively, when the global motion is not used (S1721-NO), in step S1726, inter-prediction information not including global motion information may be received, and in steps S1727 and S1728, inter-prediction without consideration of the global motion may be performed.

Herein, the global motion use/non-use signal may be global motion use/non-use information having a flag or index form.

In FIGS. 17(a) and 17(b), whether or not to use the global may be determined first, and the above step may be performed in consideration of coding efficiency or temporal calculation complexity of encoding and decoding. Accordingly, whether or not to perform inter-prediction using global motion information is determined, and an inter-prediction method may be differently applied according to the determination result.

When it is determined to use the global motion, a signal implicating that the global motion is used may be transmitted or received. In addition, inter-prediction in consideration of the global motion is performed, and information for the global motion may be transmitted or received.

When it is determined not to use the global motion, a signal implicating that the global motion is not used may be transmitted or received. In addition, inter-prediction without consideration of the global motion is performed, and information for the global motion may not be transmitted or received.

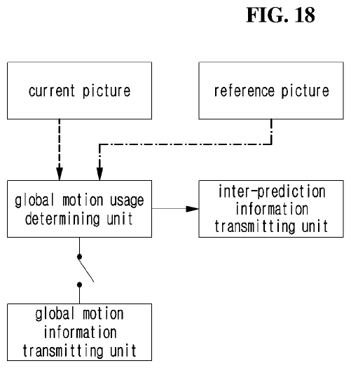

FIG. 18 is a view showing a block diagram of an encoding apparatus to which the method of selectively omitting global motion information is applied.

Referring to FIG. 18, whether or not to use a global motion may be determined in a global motion usage determining unit. According to the determination result, whether or not to transmit global motion information may be determined in a global motion information transmitting unit.

As an example of a method of selectively omitting a use of global motion information, there is provided a method of improving coding efficiency by comparing an encoding method using global motion information with an encoding method not using global motion information, and selecting the encoding method having better coding efficiency.

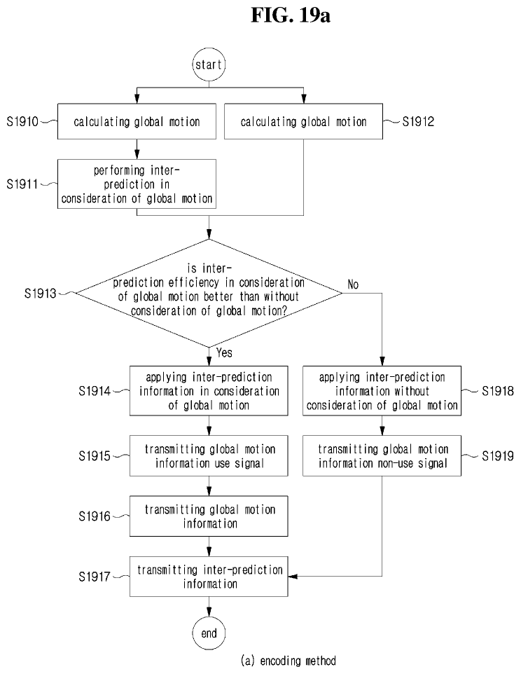

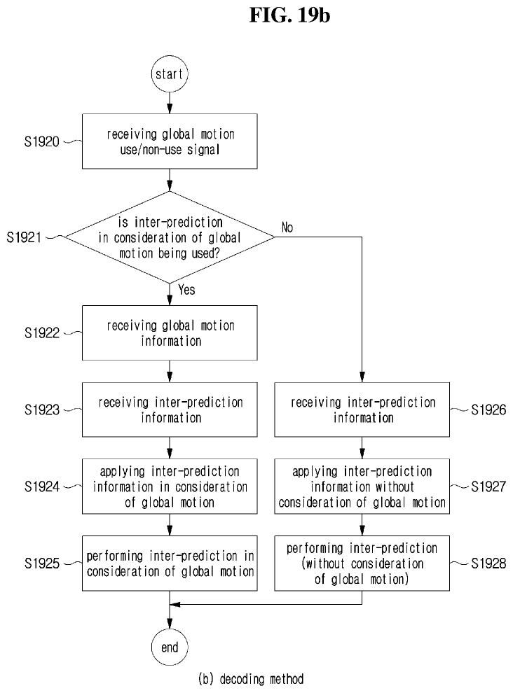

FIG. 19 is a flowchart showing an example of encoding and decoding methods that determine whether or not to use a global motion by comparing an inter-prediction result using the global motion with an inter-prediction result not using the global motion.

FIG. 19a is a flowchart showing an example of an encoding method using a method of selectively omitting global motion information.

Referring to FIG. 19a, in step S1910, a global motion may be calculated, in step S1911, inter-prediction may be performed in consideration of the global motion, and in step S1912, inter-prediction without consideration of global motion may be performed.

Then, encoding efficiencies of prediction results of steps S1911 and S1912 may be compared. When the inter-prediction efficiency in consideration of the global motion is better (S1913—YES), in step S1914, inter-prediction in consideration of the global motion is applied. In addition, in steps S1915, S1916, and S1917, a global motion information use signal and inter-prediction information including global motion information may be transmitted. Alternatively, when the inter-prediction efficiency in consideration of the global motion is worse (S1913—NO), in step S1918 inter-prediction without consideration of the global motion is applied. In addition, in steps S1918 and S1919, a global motion non-use signal and inter-prediction information not including global motion information may be transmitted.

Herein, the global motion information use signal and the global motion information non-use signal may be global motion information use/non-use information having a flag or index form.

FIG. 19b is a flowchart showing an example of a decoding method using a method of selectively omitting global motion information.

Referring to FIG. 19b, in step S1920, a global motion use/non-use signal may be received, and in step S1921, whether or not to use a global motion may be determined. When the global motion is used (S1921—YES), in steps S1922 and S1923, inter-prediction information including global motion information may be received, and in steps S1924 and S1925, inter-prediction in consideration of the global motion may be performed. Alternatively, when the global motion is not used (S1921—NO), in step S1926, inter-prediction information not including global motion information may be received, and in steps S1927 and S1928, inter-prediction without consideration of the global motion may be performed.

In FIG. 19, whether or not to use a global motion may be determined by accurately comparing encoding efficiencies between inter-prediction using the global motion and inter-prediction not using the global motion. However, a calculation amount increases. Herein, when determining whether or not inter-prediction efficiency in consideration of the global motion is better, an information amount occupied by the global motion information in a bitstream may be considered.

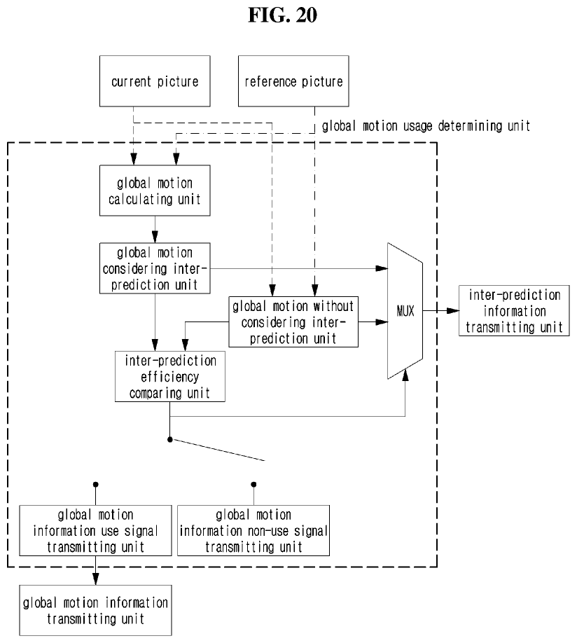

FIG. 20 is a block diagram showing an example of an image encoding apparatus that determines whether or not to use a global motion of FIG. 19.

A global motion usage determining unit of FIG. 20 may include a global motion calculating unit, a global motion considering inter-prediction unit, an inter-prediction efficiency comparing unit, a global motion without considering inter-prediction unit, a multiplexer, a global motion information use signal transmitting unit, and a global motion information non-use signal transmitting unit.

The global motion usage determining unit may determine whether or not to transmit and receive global motion information by comparing inter-prediction efficiencies between inter-prediction using the global motion and inter-prediction not using the global motion.

Image encoding and decoding methods according to an embodiment of the present invention may selectively omit global motion information according to a configuration of a reference frame.

A reference frame used when encoding and decoding a current frame may be in plural. In addition, according to a reconstruction order of a frame when encoding and decoding, an image that is temporally close with reference frames may be referenced, or an image that is temporally far away may be referenced. Herein, when a number of reference frames used for reconstructing the current frame increases, and an image having an image timing distance between the reference frame and the current frame being small is used, coding efficiency becomes high. The above characteristic may occur when a global motion is not used.

Accordingly, there are many cases in which coding efficiency is high even though a global motion is not used. On the contrary, coding efficiency may decrease by transmitting additional information that is added by using the global motion.

In consideration of the above case, a method of selectively omitting a use of a global motion may be applied. Herein, the method of omitting the use of the global motion may omit the use of the global motion according to a method predetermined according to a configuration method of a reference frame, or may determine whether or not to omit the use of the global motion when performing encoding and decoding by checking a configuration information of the reference frame.

When a use of a global motion is omitted by the present method, an additional signal or information indicating whether or not to use the global motion may be omitted, thus coding efficiency may be improved.

In addition, a step of performing both of prediction using a global motion and prediction using a local motion, and comparing results thereof may be also omitted, thus encoding calculation complexity may decrease.

Hereinafter, a method of selectively omitting global motion information according to a configuration of a reference frame will be described in detail.

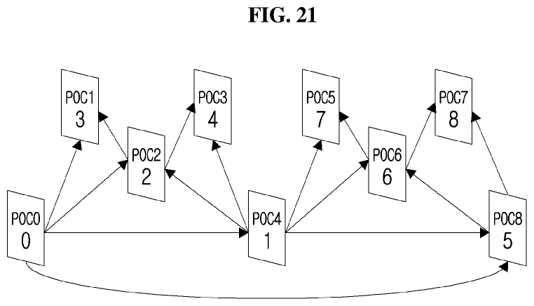

FIG. 21 shows an example of a method of configuring a reference frame in a group of picture (GOP) unit.

Each rectangular area means a picture or frame present within a GOP, and a picture order count (POC) means a temporal order of the picture or frame within a video. A number shown inside the rectangular area means a decoding order or a reconstruction order within the GOP. Arrows mean a reference configuration for decoding each frame. For example, an arrow between POC4 and POC0 means that a POC4 frame references a POC0 frame for decoding.

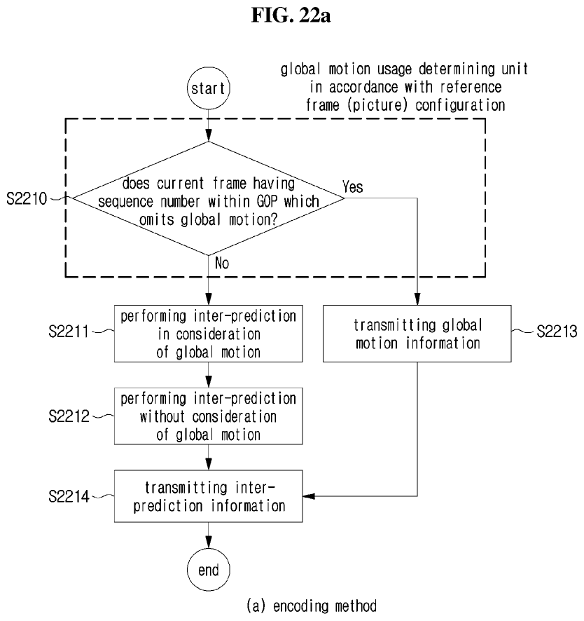

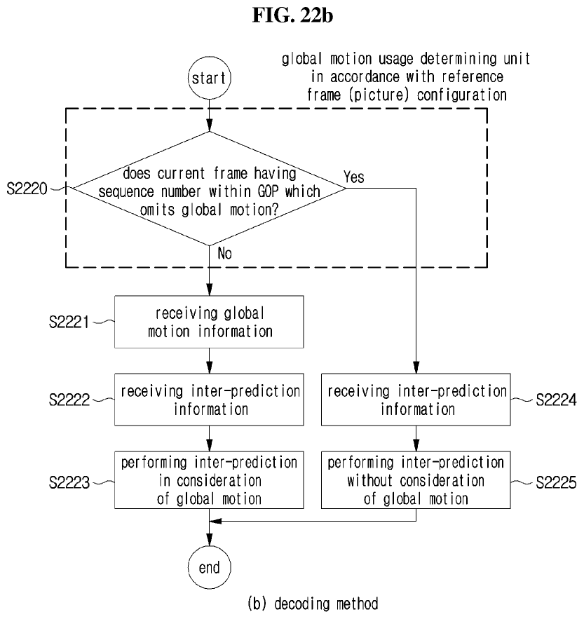

FIG. 22 is a flowchart for illustrating encoding and decoding methods of determining whether or not to use a global motion according to a pre-defined sequence number in a GOP unit.

FIG. 22a is a flowchart showing an example of encoding method using a method of selectively omitting global motion information according to a pre-defined sequence number.

Referring to FIG. 22a, whether or not a current frame has a sequence number within a GOP which omits a global motion may be determined, and when the sequence number is a pre-defined sequence number (S2210—YES), in step S2211, inter-prediction in consideration of the global motion may be performed, and in steps S2212, S2214, inter-prediction information including global motion information may be transmitted. Alternatively, when the sequence number is a sequence number not using the global motion (S2210—NO), in step S2213, inter-prediction without consideration of the global motion may be performed, and in step S2214, inter-prediction information not including global motion information may be transmitted.

FIG. 22b is a flowchart showing an example of a decoding method using a method of selectively omitting global motion information according to a pre-defined sequence number.

Referring to FIG. 22b, whether or not a current frame has a sequence number within a GOP which omits a global motion may be determined, and when the sequence number is a pre-defined sequence number (S2220—YES), in steps S2221 and S2222, inter-prediction information including global motion information may be received, and in step S2223, inter-prediction in consideration of the global motion may be performed. Alternatively, when the sequence number is a sequence number not using the global motion (S2220—NO), in step S2224, inter-prediction information not including global motion information may be received, and in step S2225, inter-prediction without consideration of the global motion may be performed.

In FIGS. 22a and 22b, when encoding and decoding by using a pre-defined sequence number according to a configuration method of a reference frame, whether or not to use global motion information may be determined without transmitting and receiving an additional signal. Herein, the pre-defined sequence number may be a reconstruction order that is pre-defined in the encoding apparatus and the decoding apparatus, or may be a POC.

In other words, when a reference frame included in a GOP of a current frame has a pre-defined sequence number, a global motion may not be used.

Alternatively, when the reference frame does not have the pre-defined sequence number, the global motion may be used, and global motion information may be transmitted and received. Meanwhile, as a reconstruction order within the GOP, a pre-defined reconstruction order may be used, or a method of inversely estimating by using a POC number may be used.

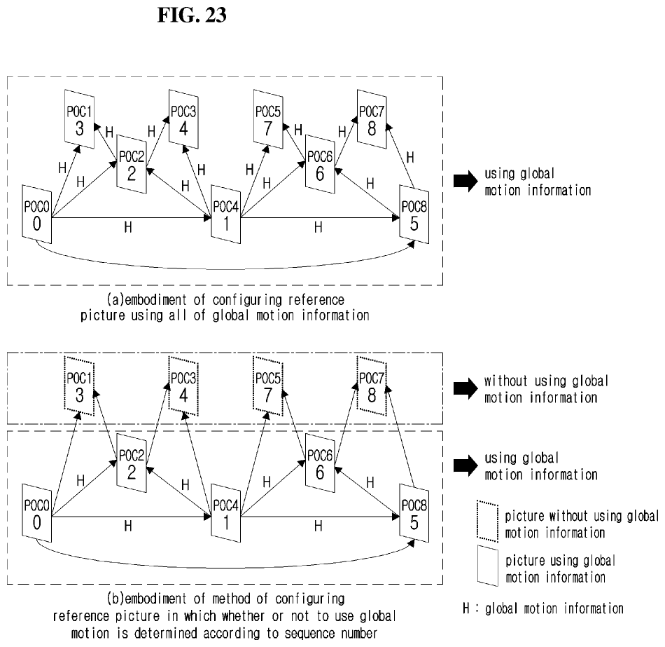

FIG. 23 is a view for illustrating a method of configuring a reference frame to which a method of determining whether or not to use a global motion according to a pre-defined sequence number of FIG. 22 is applied.

FIG. 23(a) shows an example of decoding using global motion information with frames referenced by all frames, and arrows mean reference configurations for decoding respective frames. For example, an arrow between POC4 and POC0 means that a POC4 frame references a POC0 frame for decoding. Herein, in all cases in which arrow connections are present, global motion information is present. A symbol H of FIG. 23 means global motion information. In FIG. 23(a), all of global motion information is transmitted from the encoder to the decoder.

FIG. 23(b) shows an example of a method of configuring a reference frame to which an example of FIG. 22 is applied. A case in which numbers representing a decoding order within a GOP are 3, 4, 7, and 8 is an example that is designated to omit a usage of a global motion. Accordingly, in arrow connections indicating frames having decoding order numbers 3, 4, 7, and 8, global motion information is not present, and global motion information may not be transmitted in FIG. 23(b). Frames having numbers 3, 4, 7, and 8 may be the highest temporal layer or frames corresponding to a temporal layer greater than a specific temporal layer. Herein, the temporal layer may mean a case in which a layer is divided when configuring a reference frame during encoding and decoding according to a temporal structure of a frame. A frame of a specific layer may be encoded by referencing a frame of a layer identical to or lower than itself.

In general, when a temporal layer structure is applied, and a temporal layer belongs to a higher layer, a timing distance between reference frames becomes small, and a number of reference frames increases. Accordingly, coding efficiency may become high. When the temporal layer becomes high, coding efficiency may become high even though global motion information is not included. Herein, coding efficiency may decrease since an amount occupied by the global motion information within a bitstream becomes high. Therefore, a use of a global motion of a POC corresponding to a high temporal layer may be omitted.

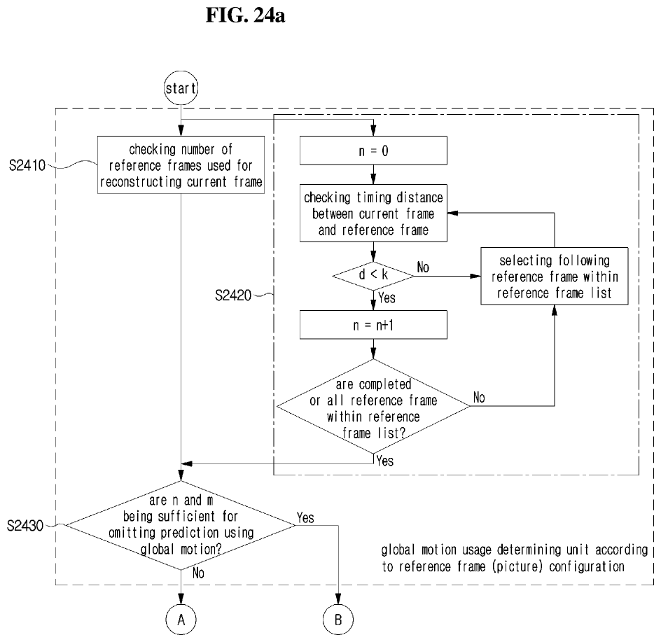

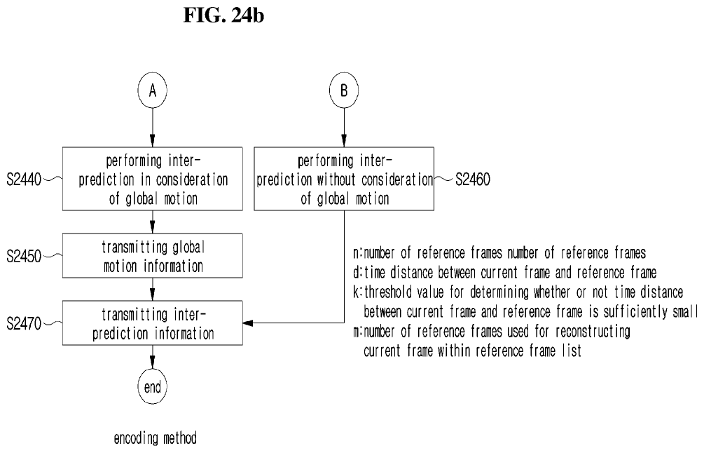

FIG. 24 is a flowchart for illustrating an encoding method of determining whether or not to adaptively use a global motion according to configuration information of a reference picture.

Different to FIG. 22 showing an example of omitting a usage of a global motion according to a reference frame having a pre-defined sequence number, FIG. 24 shows an example of encoding and decoding methods to which a method of directly determining whether or not to use a global motion for each case by using configuration information of a reference frame.

Referring to FIGS. 24a and 24b, in step S2410, a number (m) of reference frames used for reconstructing a current frame may be checked, and in step S2420, a number (n) of reference frames having timing distances (d) with the current frame within a reference frame list being smaller than a threshold value (k) may be checked. Herein, the timing distance (d) between the current frame and the reference frame may be a difference value of POCs. In addition, in step S2430 whether or not to omit a global motion may be determined based on the checked n and m numbers. When it is determined that the global motion may not be omitted (S2430—NO), in step S2440, inter-prediction in consideration of the global motion may be performed, and in steps S2450 and S2470, inter-prediction information including global motion information may be transmitted. Alternatively, when it is determined that the global motion is omitted (S2430—YES), in step S2460, inter-prediction without consideration of the global motion may be performed, and in step S2470, inter-prediction information not including global motion information may be transmitted.

In FIG. 24, whether or not to use a global motion may be determined based on a number (m) of reference frames, and a number of reference frames having timing distance (d) with a current frame within a reference frame list being smaller than a threshold value (k). In addition, a number (n) of reference frames used for reconstructing the current frame means a number of reference frames that may be used for reconstructing the current frame, and the total number of reference frames within the reference frame list or a maximum number of reference frames that may be used for prediction at one time may be included thereto.

In an example of FIG. 24, a number of reference frames used for reconstructing a current frame, and a number of reference frames having timing distances with the current frame within a reference frame list being smaller than a threshold value are used in combination. However, whether or not to use a global motion may be determined by using one of the two numbers.

In addition, whether or not to use a global motion may be determined by considering at least one of a minimum POC difference value and a frequency of the minimum POC difference value.

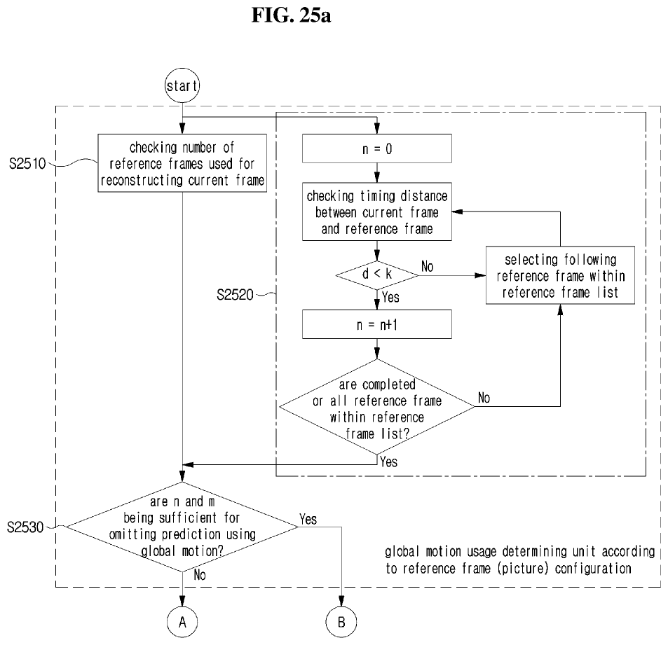

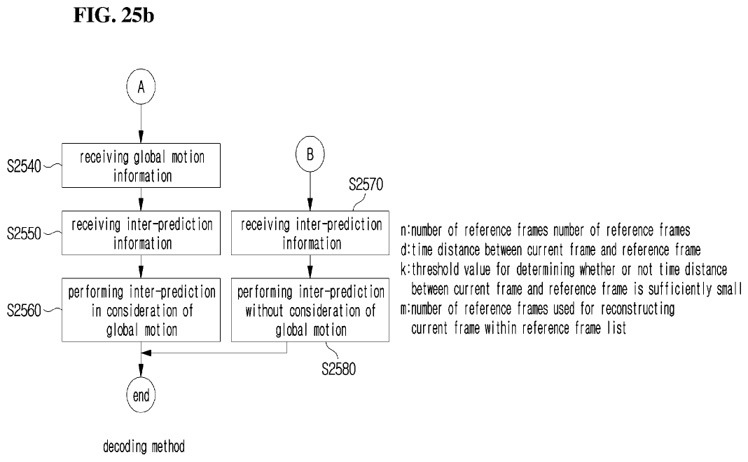

FIG. 25 is a flowchart for illustrating an example of decoding method in association with FIG. 24.

Referring to FIGS. 25a and. 25b, in step S2510, a number (m) of reference frames used for reconstructing a current frame may be checked, and in step S2520, a number (n) of reference frames having timing distances (d) with the current frame within a reference frame list being smaller than a threshold value (k) may be checked. Herein, the timing distance (d) between the current frame and the reference frame may be a difference value of POCs. In addition, in step S2530, whether or not to omit the global motion may be determined based on the checked n and m numbers. When it is determined that the global motion may not be omitted (S2530—NO), in step S2540 and S2550, inter-prediction information including global motion information may be received, and in step S2560, inter-prediction in consideration of the global motion may be performed. Alternatively, when it is determined that the global motion may be omitted (S2530—YES), in step S2570, inter-prediction information not including global motion information may be received, and in step S2580, inter-prediction without consideration of the global motion may be performed.

In the decoding method of FIG. 25, whether or not to use a global motion may be determined by using the same method of the encoding method of FIG. 24. Since the above determination step is identically performed when encoding and decoding, coding efficiency may be improved since there is no need to transmit and receive an additional signal or information which indicates whether or not to use the global motion.

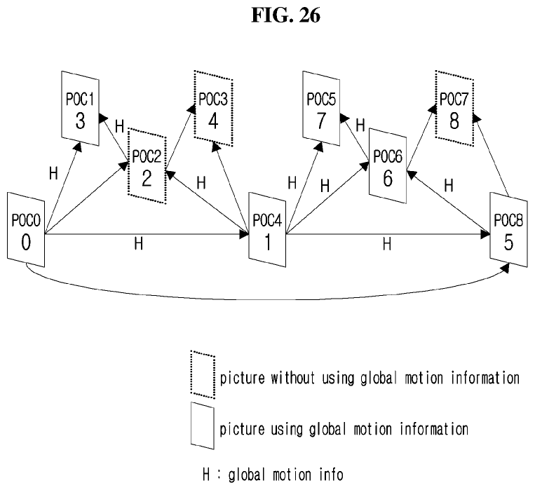

FIG. 26 shows an example of a reference picture configuration to which examples of FIGS. 24 and 25 are applied. A global motion non-use picture may be selected according to a predetermined determination criterion. Accordingly, according to the determination criterion, the global motion non-using picture may vary. A picture selected as the global motion non-use picture may not perform prediction using global motion information. Accordingly, in an arrow connection indicating the selected global motion non-use picture, global motion information is not present. Herein, there is no need to transmit global motion information.

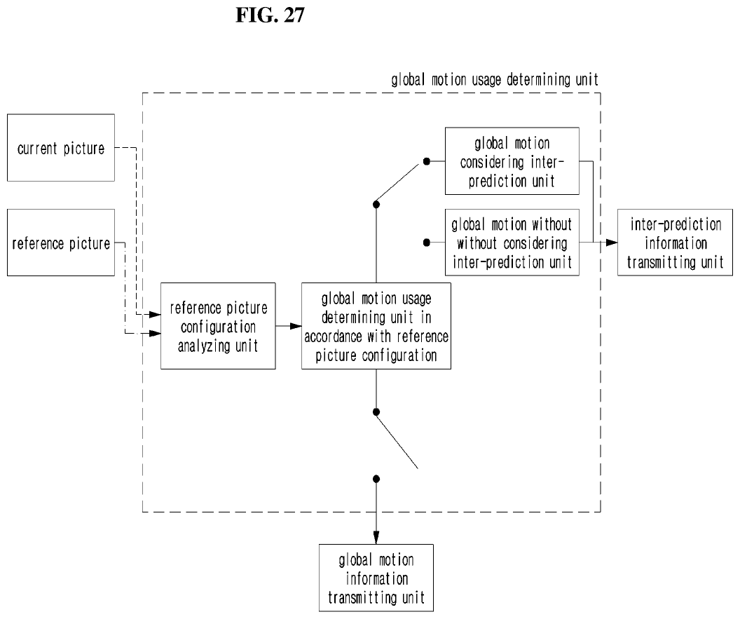

FIG. 27 is a flowchart showing an example of an encoding apparatus of determining whether or not to use a global motion by using a method of analyzing a reference picture configuration.

Referring to FIG. 27, the global motion usage determining unit may include a reference picture configuration analyzing unit, a global motion usage determining unit in accordance with reference picture configuration, a global motion considering inter-prediction unit, and a global motion without considering inter-prediction unit.

Herein, the reference picture configuration analyzing unit and the global motion use determining unit in accordance with reference picture configuration may vary according to a determination criterion.

For example, in FIG. 22, whether or not to use a global motion is determined according to a sequence number pre-defined according to a GOP structure, and the reference picture configuration analyzing unit checks a sequence number of a current picture within a GOP. Accordingly, the global motion usage determining unit in accordance with reference picture configuration determines whether or not to use the global motion. When it is determined to use the global motion, the global motion considering inter-prediction unit and the global motion information transmitting unit are operated. When it is determined not use the global motion, the global motion without considering inter-prediction unit is operated, and the global motion information transmitting unit is not operated.

In FIG. 24, since whether or not to use a global motion is determined according to a timing distance between a reference picture and a current picture and a number of reference frames used for reconstructing a current frame, the reference picture configuration analyzing unit checks the timing distance between the reference picture and the current picture, and the number of reference frames used for reconstructing the current frame. Accordingly, the global motion usage determining unit in accordance with reference picture configuration determines whether or not to use the global motion. When it is determined to use the global motion, the global motion considering inter-prediction unit and the global motion information transmitting unit are operated. When it is determined not to use the global motion, the global motion without considering inter-prediction unit is operated, and the global motion information transmitting unit is not operated.

In the image encoding and decoding methods according to an embodiment of the present invention, global motion information may be selectively omitted according to a characteristic of a global motion.

Global motion information represents how an inter-global motion occurs. Accordingly, a size and a direction, or a characteristic of the global motion may be determined by using the global motion information. Herein, when a global motion determined by using the global motion information is small or a loss of prediction accuracy which is generated when the characteristic is replaced with a local motion prediction is small, coding efficiency may be improved by omitting a use of the global motion information. Herein, the characteristic of the global motion refers to a parallel movement, a rotation, a scaling up/down, a perspective modification, a configuration element of a combined global motion, etc.

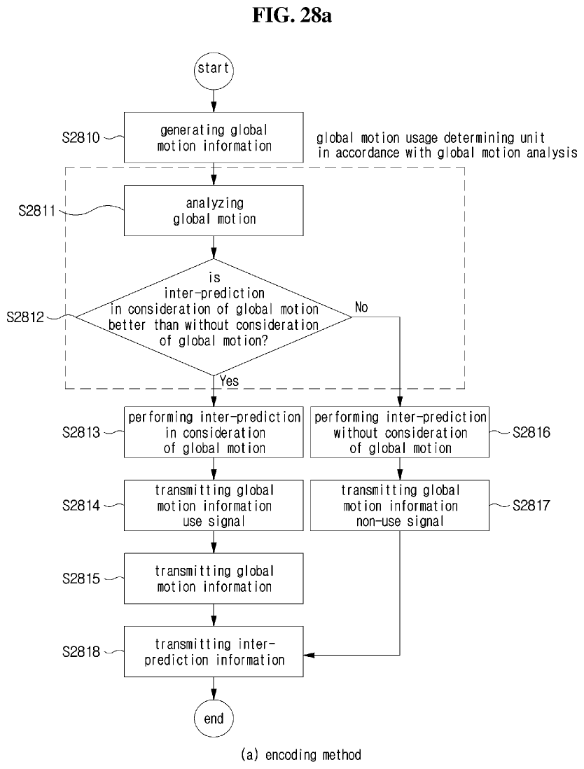

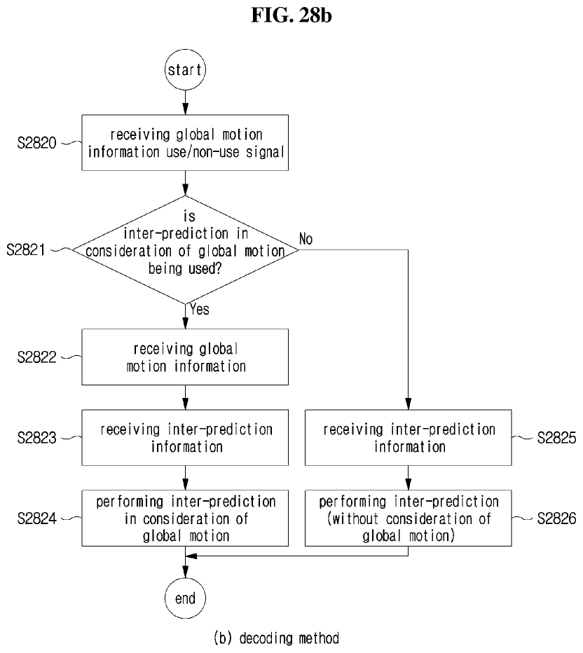

FIG. 28 is a flowchart showing an example of encoding and decoding methods of determining whether or not to use global motion information by analyzing generated global motion information.

FIG. 28a is a flowchart showing an example of an encoding method of determining whether or not to use global motion information by analyzing generated global motion information.

Referring to FIG. 28a, in step S2810, global motion information may be generated, in step S2811, the global motion information may be analyzed, and in step S2812, whether or not inter-prediction in consideration of the global motion is better may be determined. Herein, the analyzed global motion information may be a size of the global motion and a characteristic of the global motion. In addition, a step of determining whether or not inter-prediction in consideration of the global motion is better may be performed based on the size of the global motion, the characteristic of the global motion, and whether or not encoding/decoding method using the global motion is.

For example, when a prediction method using a global motion is added to a conventional HEVC (high efficiency video coding) method, a local motion prediction method in a HEVC has good prediction efficiency when there is a global motion generated by a parallel movement. However, prediction efficiency becomes very low when there is a global motion generated by a rotation movement or a global motion generated by a scaling up/down. Accordingly, by analyzing global motion information generated when encoding, coding efficiency may be improved by performing prediction using the global motion when a characteristic of a global motion between a current picture and reference picture is a rotation movement or a scaling up/down, and by omitting prediction using the global motion when the characteristic of the global motion is a parallel movement.

In addition, whether or not to omit a transmission of global motion information may be determined by analyzing a characteristic of the global motion, analyzing a size of the global motion according to the characteristic, and adding an additional determination criterion.

In addition, when it is determined that inter-prediction in consideration of the global motion is better (S2812—YES), in step S2813, inter-prediction in consideration of the global motion may be performed, and in steps S2814, S2815, and S2818, a global motion information use signal and inter-prediction information including global motion information may be respectively transmitted. Alternatively, when it is determined that inter-prediction in consideration of the global motion is not better (S2812-NO), in step S2816, inter-prediction without consideration of the global motion may be performed, and in steps S2817 and S2818, a global motion information non-use signal and inter-prediction information not including global motion information may be respectively transmitted.

Herein, the global motion information use signal and the global motion information non-use signal may be global motion information use/non-use information having a flag or index form.

FIG. 28b is a flowchart showing an example of a decoding method of determining whether or not to use global motion information by using generated global motion information.

Referring to FIG. 28b, in step S2820, a global motion use/non-use signal may be received, and in step S2821, whether or not to use a global motion may be determined. When it is determined to use the global motion (S2821—YES), in steps S2822 and S2823, inter-prediction information including global motion information may be received, and in step S2824, inter-prediction in consideration of the global motion may be performed. Alternatively, when it is determined not to use the global motion (S2821—NO), in step S2825, inter-prediction information not including global motion information may be received, and in step S2826, inter-prediction without consideration of the global motion may be performed.

A process of analyzing global motion information and determining whether or not to use a global motion according to the determination result may be performed based on information of a size and a characteristic of the global motion which is included in the global motion information, and encoding and decoding methods not using the global motion.

When whether or not to use the global motion is determined as above, information of whether or not to use the global motion is transmitted so that whether or not to use the global motion is identically determined in the decoder. The above process is performed since the decoder does not know the global motion information so that it is not possible to perform identical analysis and determination.

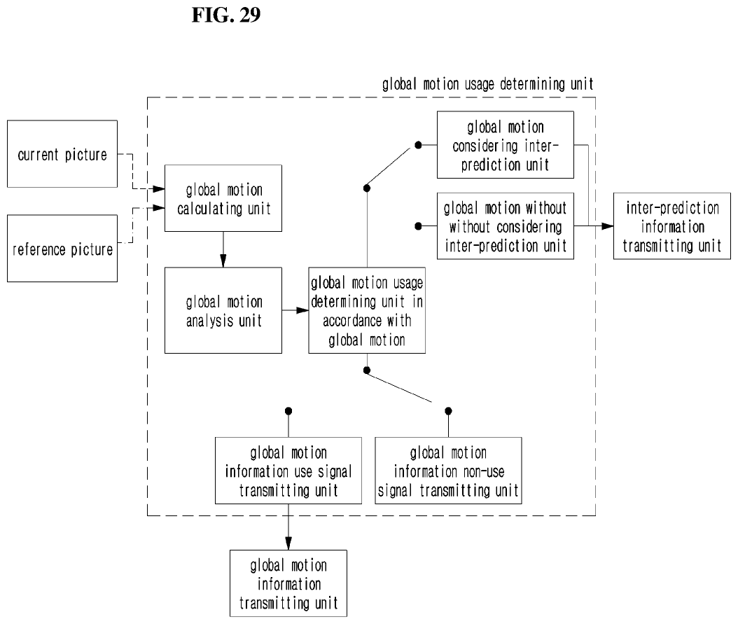

FIG. 29 is a view showing an example of an encoding apparatus to which an encoding method of FIG. 28 is applied.

Referring to FIG. 29, the global motion usage determining unit may include a global motion calculating unit, a global motion analyzing unit, a global motion usage determining unit in accordance with global motion, a global motion information use signal transmitting unit, a global motion information non-use signal transmitting unit, a global motion considering inter-prediction unit, and a global motion without considering inter-prediction unit.

In FIG. 29, data for determining whether or not to use a global motion is generated by using a global motion that is previously calculated in the global motion analyzing unit. The generated data is used for determining whether or not to use the global motion in the global motion usage determining unit in accordance with global motion. Herein, the global motion may not be analyzed and used in an original state thereof. When the global motion is used, information notifying that global motion information is used, and global motion information may be transmitted and received, and inter-prediction in consideration of the global motion may be performed. Alternatively, when the global motion is not used, information notifying that global motion information is not used may be transmitted and received, and inter-prediction without consideration of the global motion may be performed.

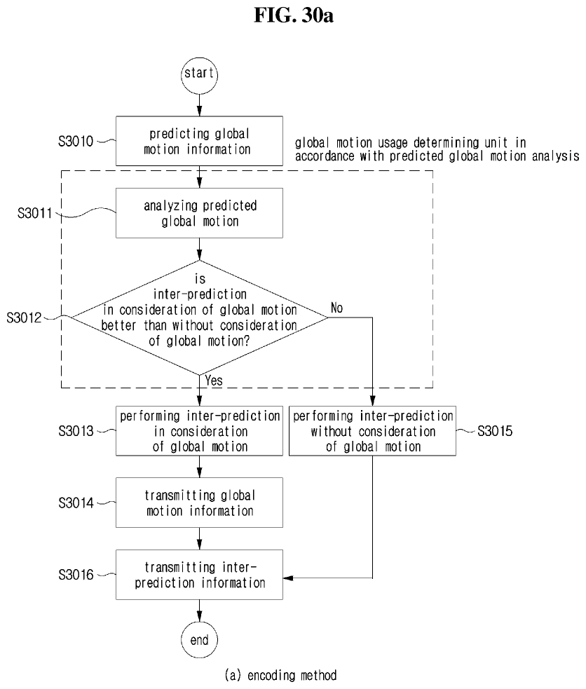

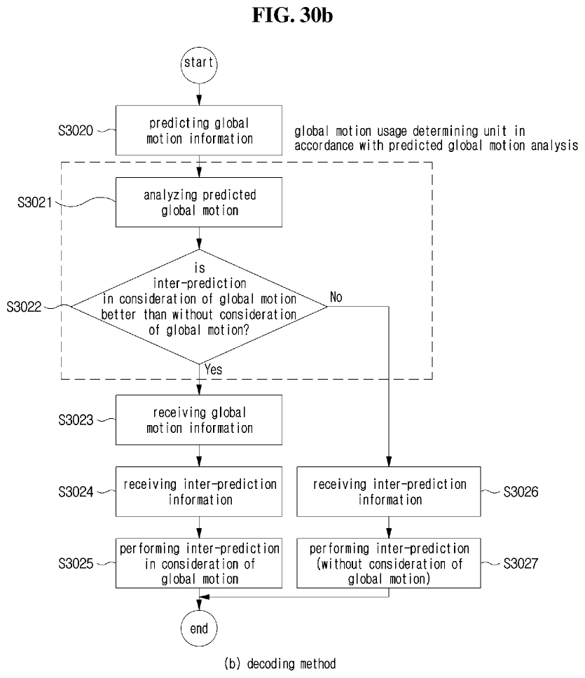

FIG. 30 shows encoding and decoding methods of determining whether or not to use global motion information by analyzing predicted global motion information. In FIG. 28, whether or not to use a global motion is determined by analyzing a generated global motion. However, in FIG. 30, whether or not to use a global motion may be determined by predicting global motion information and analyzing the predicted global motion information.

FIG. 30a is a flowchart showing an example of an encoding method of determining whether or not to use global motion information by analyzing predicted global motion information.

Referring to FIG. 30a, in step S3010, global motion information may be predicted, in step S3011, the predicted global motion information may be analyzed, and in step S3012, whether or not inter-prediction in consideration of the global motion is better may be determined.

In addition, when it is determined that inter-prediction in consideration of the global motion is better (S3012—YES), in step S3013, inter-prediction in consideration of the global motion may be performed, and in steps S3014 and S3016, inter-prediction information including global motion information may be transmitted. Alternatively, when it is determined that inter-prediction in consideration of the global motion is not better (S3012-NO), in step S3015, inter-prediction without consideration of the global motion may be performed, and in step S3016, inter-prediction information not including global motion information may be transmitted.

FIG. 30b is a flowchart showing an example of a decoding method of determining whether or not to use global motion information by analyzing predicted global motion information.

Referring to FIG. 30b, in step S3020, global motion information may be predicted, in step S3021, the predicted global motion information may be analyzed, and in step S3022, whether inter-prediction in consideration of the global motion is better may be determined.

In addition, when it is determined that inter-prediction in consideration of the global motion is better (S3022—YES), in step S3023 and S3024, inter-prediction information including global motion information may be received, and in step S3025, inter-prediction in consideration of the global motion may be performed. Alternatively, when it is determined that inter-prediction in consideration of the global motion is not better (S3022-NO), in step S3026, inter-prediction information not including global motion information may be received, and in step S3027, inter-prediction without consideration of the global motion may be performed.

In FIG. 30, when a process of storing a global motion that is previously reconstructed, and predicting a global motion by using the same is included, and whether or not to transmit a global motion may be determined by using the predicted global motion information rather than calculated global motion information of FIG. 28. Herein, a transmission of a signal representing whether or not to use a global motion may be omitted since the same process may be performed in the encoder and the decoder.

Herein, apart from coding efficiency using a global motion, whether or not to transmit the global motion may be determined by a prediction accuracy of the global motion. When the prediction accuracy of the global motion is high, inter-prediction using the global motion may be performed, but a transmission of global motion information may be omitted. When the prediction accuracy of the global motion is low, inter-prediction using the global motion may be also performed, and global motion information may be transmitted, or information indicating a difference between predicted global motion information and calculated global motion information may be transmitted so that a process of correcting the predicted global motion information to be identical or similar to the calculated global motion information may be performed.

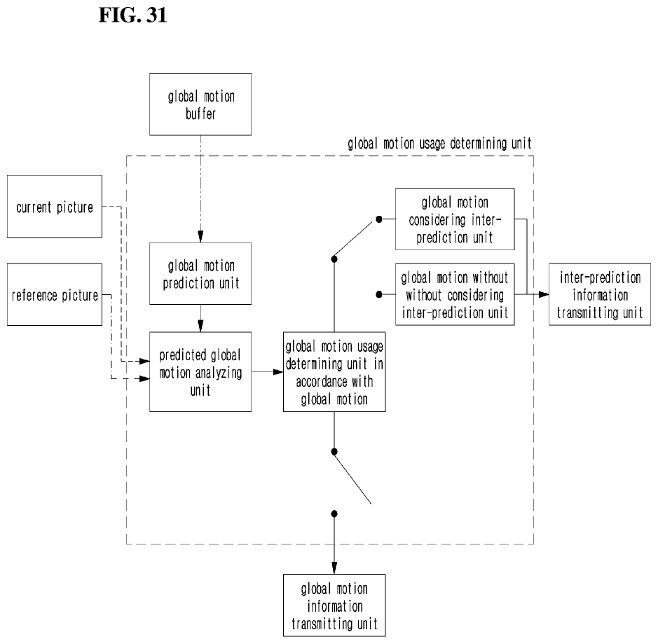

FIG. 31 is a view showing an example of an encoding apparatus to which a method of FIG. 30 is applied.

Referring to FIG. 31, the global motion usage determining unit may include a global motion prediction unit, a predicted global motion analyzing unit, a global motion usage determining unit in accordance with global motion, a global motion inter-prediction unit, and a global motion without considering inter-prediction unit.

In an encoding apparatus of FIG. 31, different to an example of FIG. 29, the global motion calculating unit may not be required, and the global motion prediction may be used. The predicted global motion is used instead of calculated global motion information of FIG. 29 for determining whether or not to use a global motion. When the global motion is used, different to an example of FIG. 29, information notifying that global motion information is used may not be transmitted. In addition, the global motion information may be transmitted and received, and inter-prediction in consideration of the global motion may be performed. Herein, a transmission and a reception of the global motion information may be omitted.

When the global motion is not used, different to an example of FIG. 29, information notifying that the global motion information is not used may not be transmitted and received, and inter-prediction without consideration of the global motion may be performed.

Meanwhile, in the image encoding and decoding methods according to an embodiment of the present invention, global motion information may be selectively omitted according to a usage frequency of the global motion information.

When a prediction method using a global motion is used since coding efficiency for decoding a previous frame was high, the prediction method using the global motion may be also used for a current frame since there is high probability that coding efficiency becomes high. In addition, when the prediction method using the global motion is used at a high frequency for previously decoded frames, there is high probability of using the global motion for the current frame. Accordingly, coding efficiency may be improved by predicting a signal representing whether or not to use global motion information.

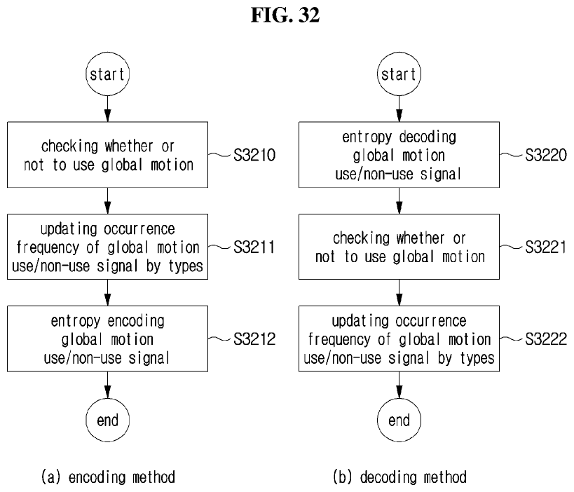

FIG. 32 is a flowchart showing entropy encoding and decoding methods of a signal representing whether or not to use a global motion.

Referring to FIG. 32(a), in step S3210, whether or not to use a global motion may be checked, and in step S3211, an occurrence frequency of a global motion use/non-use signal may be updated by types. In addition, in step S3212, the global motion use/non-use signal may be entropy encoded.

Referring to FIG. 32(b), in step S3220, a global motion use/non-use signal may be entropy decoded, and in step S3221, whether or not to use a global motion may be checked. In addition, in step S3222, an occurrence frequency of the global motion use/non-use signal may be updated by types.

FIG. 32 shows an example of a method of increasing coding efficiency by predicting a signal representing whether or not to use global motion information, and shows a method of compressing a signal representing whether or not to use global motion information by using an entropy coding method. In addition, a transmission of a signal representing whether or not to use global motion information may be omitted or compressed by determining a use of global motion information according to an occurrence frequency thereof or according to whether or not the global motion information has been used for a neighbor frame.

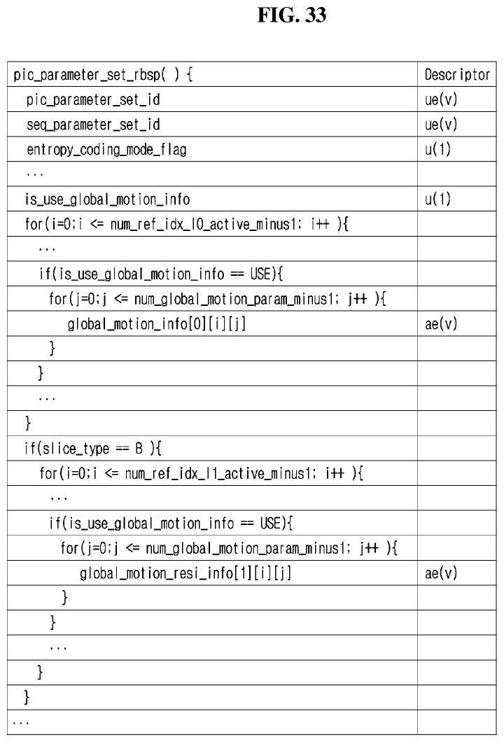

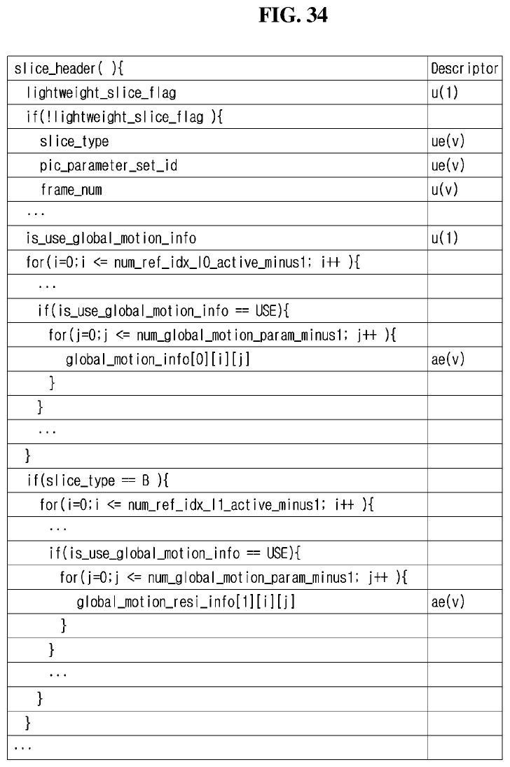

FIGS. 33 and 34 are views showing a syntax used in a method of selectively omitting global motion information of the present invention.

FIG. 33 shows an example when the present invention is applied to a PPS syntax in a picture unit. is_use_global_motion_info is a signal representing whether or not to use global motion information of a corresponding picture. When is_use_global_motion_info is ‘USE’, it may mean that the global motion information is used, otherwise, it may mean that the global motion information is omitted. Accordingly, values representing the global motion information which is global_motion_info may be received when is_use_global_motion_info is ‘USE’.

FIG. 34 shows an example when the present invention is applied to a slice header syntax in a slice unit. is_use_global_motion_info is a signal representing whether or not to use global motion information of a corresponding slice. When is_use_global_motion_info is USE, it may mean that the global motion information is used, otherwise, it may mean that global motion information is omitted. Accordingly, values representing the global motion information which is global_motion_info may be received when is_use_global_motion_info is USE.

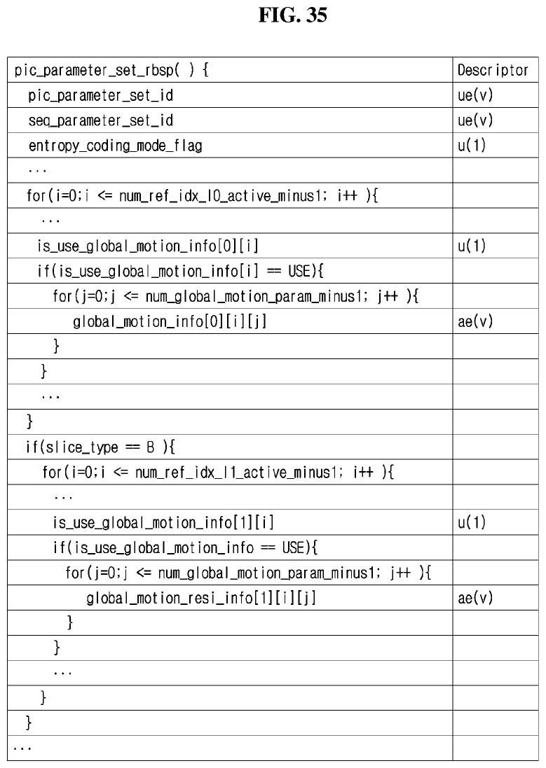

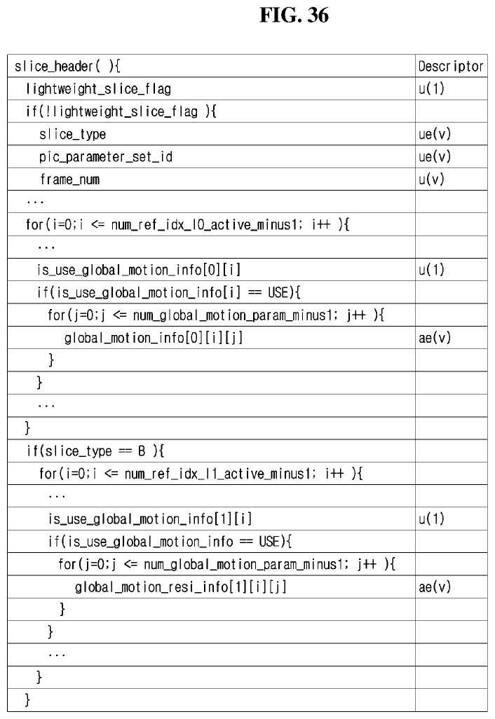

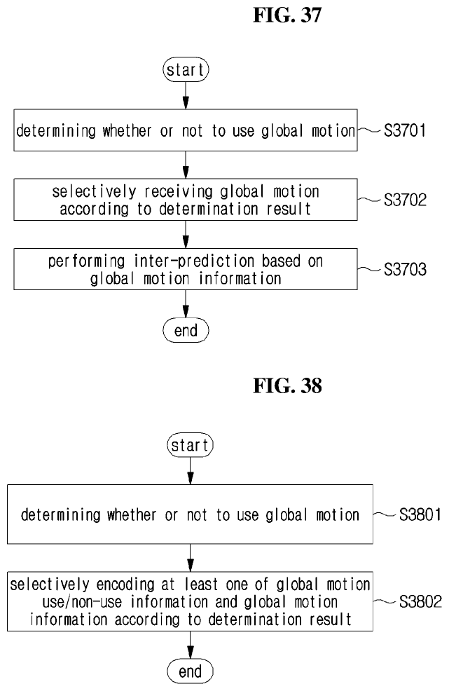

FIG. 35 shows an example when the present invention is applied to a PPS syntax in a reference picture unit. is_use_global_motion_info[n][i] is a signal representing whether or not to use global motion information of an i-th reference picture within an n-th reference picture list of a corresponding picture. When is_use_global_motion_info[n][i] is true, it may mean that the global motion information is used, otherwise, it may mean that the global motion information is omitted. Accordingly, values representing whether or not to use the global motion information of the i-th reference picture within the n-th reference picture list may be received when is_use_global_motion_info[n][i] is USE.

FIG. 36 shows an example when the present invention is applied to a slice header syntax in a reference picture unit. is_use_global_motion_info[n][i] is a signal representing whether or not to use global motion information of an i-th reference picture within an n-th reference picture list of a corresponding picture. When is_use_global_motion_info[n][i] is true, it may mean that the global motion information is used, otherwise, it may mean that global motion information is omitted.

Accordingly, values representing the global motion information of the i-th reference picture within the n-th reference picture list which is global_motion_info[n][i] may be received when is_use_global_motion_info[n][i] is USE.

FIG. 37 is a flowchart for illustrating an image decoding method according to an embodiment of the present invention.

Referring to FIG. 37, in step S3701, whether or not to use a global motion may be determined, and in step S3702, global motion information may be selectively received according to the determination result. In detail, when it is determined to use the global motion, in step S3703, inter-prediction information including the global motion information may be obtained from a bitstream, and inter-prediction may be performed based on the obtained global motion information.

Alternatively, when it is determined not to use the global motion, inter-prediction information not including global motion information may be obtained from a bitstream, and inter-prediction not using the global motion may be performed.

As an example of determining whether or not to use a global motion, whether or not to use a global motion may be determined based on information representing whether or not to use a global motion which is obtained from a bitstream. A detailed description thereof will be omitted since it has been described in detail with reference to FIGS. 17(b), 19(b), and 28(b).

As another example of determining whether or not to use a global motion, whether or not to use a global motion may be determined based on a prediction result of coding efficiency according to whether or not to use a global motion of a reference picture within a reference picture list of a current picture. Herein, coding efficiency according to whether or not to use a global motion may be predicted based on at least one of a POC of a reference picture, a number of reference picture within a reference picture list, a POC distance between a reference picture and a current picture, and a characteristic of global motion information.

As another example of determining whether or not to use a global motion, whether or not to use a global motion may be determined in a unit identical to or higher than a unit in which global motion information is transmitted.

As another example of determining whether or not to use a global motion, whether or not to use a global motion may be determined based on a POC or temporal layer information of a reference picture within a reference picture list of a current picture. A detailed description thereof will be omitted since it has been described in detail with reference to FIG. 22(b).

As another example of determining whether or not to use a global motion, whether or not to use a global motion may be determined based on at least one of a number of reference pictures within a reference picture list of a current picture, and a POC distance between a current picture and a reference picture. A detailed description thereof will be omitted since it has been described in detail with reference to FIG. 25.

As another example of determining whether or not to use a global motion, whether or not to use a global motion may be determined by predicting global motion information and determining whether or not to use a global motion based on a characteristic of the predicted global motion information.

Herein, the characteristic of the predicted global motion information may include at least one of a rotation, a scaling up, a scaling down, a parallel movement, and a perspective movement. Herein, it may be determined to use the global motion when the characteristic of the predicted global motion information corresponds to at least one of a rotation, a scaling up, a scaling down, a parallel movement, and a perspective movement. In addition, whether or not to use a global motion may be determined based on a size of the predicted global motion information. Herein, the parallel movement may be any one or a horizontal movement, a vertical movement, and a horizontal/vertical combined movement. A detailed description thereof will be omitted since it has been described in detail with reference to FIG. 30(b).

FIG. 38 is a flowchart for illustrating an image encoding method according to an embodiment of the present invention.

Referring to FIG. 38, in step S3801, whether or not to use a global motion may be determined, and in step S3802, at least one of information representing whether or not to use a global motion and global motion information may be determined according to the determination result. In detail, when it is determined to use a global motion, global motion information may be encoded, and inter-prediction applying the global motion information may be performed. Herein, global motion use/non-use information indicating that a global motion is used may be further encoded and included in a bitstream.

Alternatively, when it is determined not to use a global motion, global motion information may not be encoded, and inter-prediction without applying global motion information may be performed. Herein, global motion use/non-use information indicating that a global motion is not used may be further encoded and included in a bitstream.

As an example of determining whether or not to use a global motion, whether or not to use a global motion may be determined based on coding efficiency according to whether or not to use a global motion of a reference picture within a reference picture list of a current picture.

As another example of determining whether or not to use a global motion, whether or not to use a global motion may be determined based a prediction result of coding efficiency according to whether or not to use a global motion of a reference picture within a reference picture list of a current picture. Herein, coding efficiency according whether or not to use a global motion may be predicted based on at least one of a POC of a reference picture [symbol] POC, a number of reference pictures within a reference picture list, a POC distance between a reference picture and a current picture, and a characteristic of global motion information.

As another example of determining whether or not to use a global motion, whether or not to use a global motion may be determined in a unit that is identical to or higher than a unit in which global motion information is transmitted.

As an example of determining whether or not to use a global motion, whether or not to use a global motion may be determined based on a POC or temporal layer information of a reference picture within a reference picture list of a current picture. A detailed description thereof will be omitted since it has been described in detail with reference to FIG. 22(a).

As another example of determining whether or not to use a global motion, whether or not to use a global motion may be determined based on at least one of a number of reference pictures within a reference picture list of a current picture and a POC distance between a current picture and a reference picture. A detailed description thereof will be omitted since it has been described in detail with reference to FIG. 24.

As another example of determining whether or not to use a global motion, whether or not to use a global motion may be determined by predicting global motion information, and determining whether or not to use a global motion based on a characteristic of the predicted global motion information.

Herein, the characteristic of the predicted global motion information may include at least one of a rotation, a scaling up, a scaling down, a parallel movement, and a perspective movement. Herein, it may be determined to use the global motion when the characteristic of the predicted global motion information corresponds to at least one of a rotation, a scaling up, a scaling down, a parallel movement, and a perspective movement. In addition, whether or not to use the global motion may be determined based on a size of the predicted global motion information. Herein, the parallel movement may be any one of a horizontal movement, a vertical movement, and a horizontal/vertical combined movement. A detailed description thereof will be omitted since it has been described with reference to detail in 30(a).

Meanwhile, a storage medium according to the present invention may store a bitstream generated by an image encoding method including determining whether or not to use a global motion, and selectively encoding at least one of global motion use/non-use information and global motion information according to the determination result. Herein, the image encoding method may be an image encoding method described in FIG. 38.

The above embodiments may be performed in the same method in an encoder and a decoder.

A sequence of applying to above embodiment may be different between an encoder and a decoder, or the sequence applying to above embodiment may be the same in the encoder and the decoder.

The above embodiment may be performed on each luma signal and chroma signal, or the above embodiment may be identically performed on luma and chroma signals.

A block form to which the above embodiments of the present invention are applied may have a square form or a non-square form.

The above embodiment of the present invention may be applied depending on a size of at least one of a coding block, a prediction block, a transform block, a block, a current block, a coding unit, a prediction unit, a transform unit, a unit, and a current unit. Herein, the size may be defined as a minimum size or maximum size or both so that the above embodiments are applied, or may be defined as a fixed size to which the above embodiment is applied. In addition, in the above embodiments, a first embodiment may be applied to a first size, and a second embodiment may be applied to a second size. In other words, the above embodiments may be applied in combination depending on a size. In addition, the above embodiments may be applied when a size is equal to or greater that a minimum size and equal to or smaller than a maximum size. In other words, the above embodiments may be applied when a block size is included within a certain range.

For example, the above embodiments may be applied when a size of current block is 8×8 or greater. For example, the above embodiments may be applied when a size of current block is 4×4 or greater. For example, the above embodiments may be applied when a size of current block is 16×16 or greater. For example, the above embodiments may be applied when a size of current block is equal to or greater than 16×16 and equal to or smaller than 64×64.

The above embodiments of the present invention may be applied depending on a temporal layer. In order to identify a temporal layer to which the above embodiments may be applied may be signaled, and the above embodiments may be applied to a specified temporal layer identified by the corresponding identifier. Herein, the identifier may be defined as the lowest layer or the highest layer or both to which the above embodiment may be applied, or may be defined to indicate a specific layer to which the embodiment is applied. In addition, a fixed temporal layer to which the embodiment is applied may be defined.

For example, the above embodiments may be applied when a temporal layer of a current image is the lowest layer. For example, the above embodiments may be applied when a temporal layer identifier of a current image is 1. For example, the above embodiments may be applied when a temporal layer of a current image is the highest layer.

A slice type to which the above embodiments of the present invention are applied may be defined, and the above embodiments may be applied depending on the corresponding slice type.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments include various aspects of examples. All possible combinations for various aspects may not be described, but those skilled in the art will be able to recognize different combinations. Accordingly, the present invention may include all replacements, modifications, and changes within the scope of the claims.

The embodiments of the present invention may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field. Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used in an image encoding/decoding apparatus.

1. An image decoding method, the method comprising:
determining whether or not to use a global motion;
selectively receiving global motion information according to the determination result; and
performing inter-prediction based on the global motion information.

2. The image decoding method of claim 1, wherein in the determining of whether or not to use the global motion, whether or not to use the global motion is determined based on global motion use/non-use information obtained from a bitstream.

3. The image decoding method of claim 1, wherein in the determining of whether or not to use the global motion, whether or not to use the global motion is determined based on a prediction result of a coding efficiency according to whether or not to use a global motion of a reference picture within a reference picture list of a current picture.

4. The image decoding method of claim 1, wherein in determining of whether or not to use the global motion, whether or not to use the global motion is determined based on a picture order count (POC) of a reference picture within a reference picture list of a current picture.

5. The image decoding method of claim 1, wherein in the determining of whether or not to use the global motion, whether or not to use the global motion is determined based on a temporal layer of a reference picture within a reference picture list of a current picture.

6. The image decoding method of claim 1, wherein in the determining of whether or not to use the global motion, whether or not to use the global motion is determined based on at least one of a number of reference pictures within a reference picture list of a current picture, and a POC distance between the current picture and the reference picture.

7. The image decoding method of claim 1, wherein the determining of whether or not to use the global motion includes:
predicting global motion information; and
determining whether or not to use the global motion based on a characteristic of the predicted global motion information.

8. The image decoding method of claim 7, wherein the characteristic of the predicted global motion information includes at least one of a rotation, a scaling up, a scaling down, a parallel movement, and a perspective movement.

9. The image decoding method of claim 8, wherein in the determining of whether or not to use the global motion, the global motion is used when the characteristic of the predicted global motion information corresponds to at least one of the rotation, the scaling up, the scaling down, the parallel movement, and the perspective movement.

10. The image decoding method of claim 7, wherein in the determining of whether or not to use the global motion, whether or not to use the global motion is determined based on a size of the predicted global motion information.

11. An image encoding method, the method comprising:
determining whether or not to use a global motion; and
selectively encoding at least one of global motion use/non-use information, and global motion information according to the determination result.

12. The image encoding method of claim 11, wherein in the determining of whether or not to use the global motion, whether or not to use the global motion is determined based on a coding efficiency according to whether or not to use a global motion of a reference picture within a reference picture list of a current picture.

13. The image encoding method of claim 12, wherein in the determining of whether or not to use the global motion, whether or not to use the global motion is determined based on a prediction result of the coding efficiency according to whether or not to use the global motion of the reference picture within the reference picture list of the current picture.

14. The image encoding method of claim 11, wherein in the determining of whether or not to use the global motion, whether or not to use the global motion is determined based on a POC of a reference picture within a reference picture list of a current picture.

15. The image encoding method of claim 11, wherein in the determining whether or not to use the global motion, whether or not to use the global motion is determined based on at least one of a number of reference pictures within a reference picture list of a current picture, and a POC distance between the current picture and the reference picture.

16. The image encoding method of claim 11, wherein the determining of whether or not to use the global motion includes:
predicting global motion information; and
determining whether or not to use the global motion based on a characteristic of the predicted global motion information.

17. The image encoding method of claim 16, wherein the characteristic of the predicted global motion information includes at least one of a rotation, a scaling up, a scaling down, a parallel movement, and a perspective movement.

18. The image encoding method of claim 17, wherein in the determining of whether or not to use the global motion, the global motion is used when the characteristic of the predicted global motion information corresponds to at least one of the rotation, the scaling up, the scaling down, the parallel movement, and the perspective movement.

19. The image encoding method of claim 16, wherein in the determining of whether or not to use the global motion, whether or not to use the global motion is determined based on a size of the predicted global motion information.

20. A storage medium storing a bitstream generated by an image encoding method including: determining whether or not to use a global motion; and selectively encoding at least one of global motion use/non-use information, and global motion information according to the determination result.
